(19) United States
(12) Patent Application Publication
(10) Pub. No.: US 2026/0339232 A1
(43) Pub. Date: Oct. 29, 2026

(54) DEVELOPING MEMBER, ELECTROPHOTOGRAPHIC PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: SOUYA YAMANE, Shizuoka (JP); TAKASHI KOYANAGI, Shizuoka (JP)

(21) Appl. No.: 19/574,743

(22) Filed: Mar. 23, 2026

(30) Foreign Application Priority Data
Apr. 18, 2025 (JP) 2025-068772

(51) Int. Cl. G03G 15/06; C08G 18/40; C08G 18/48; C08G 18/62

(52) U.S. Cl. CPC G03G 15/06; C08G 18/4063; C08G 18/4854; C08G 18/6229; C08G 18/6233

(57) ABSTRACT

A developing member comprises a surface comprised a resin comprising an acrylic structure and a urethane structure, wherein, when a sum of carbon atoms, oxygen atoms, and nitrogen atoms detected by X-ray photoelectron spectroscopy on the surface is used as a reference, a proportion of the nitrogen atoms is defined as N1, a proportion of the oxygen atoms forming an ether structure is defined as O1, a proportion of carbon atoms that are not carbon atoms forming a carbonyl structure among the carbon atoms adjacent to oxygen is defined as C1, and a proportion of carbon atoms forming the carbonyl structure in the acrylic structure is defined as C2, formulas (A) to (C) below are satisfied:

1.08≤N1 (A);

20.0≤O1/N1≤39.8 (B); and

4.10≤C1/C2≤6.90 (C).

### BACKGROUND

### Field of the Technology

The present disclosure relates to a developing member incorporated in an apparatus using an electrophotographic system. In addition, the present disclosure relates to an electrophotographic process cartridge and an electrophotographic image forming apparatus that use the developing member.

### Description of the Related Art

An electrophotographic image forming apparatus (hereinafter also referred to as an “electrophotographic apparatus”) uses a developing member for conveying to a developing region a developer for developing an electrostatic latent image formed on an electrophotographic photoreceptor. With the recent demand for an even longer life of an electrophotographic image forming apparatus, there also has been a demand for even greater scratch resistance for a developing member.

Japanese Patent Application Laid-Open No. 2016-012130 discloses a developer carrying member having on a surface thereof a modified acrylic urethane resin disposed. In addition, Japanese Patent Application Laid-Open No. 2020-008847 discloses an electrophotographic member in which a cross-linked urethane resin and a cross-linked acrylic resin form an interpenetrating polymer network structure.

The present inventors have recognized that the electrophotographic members disclosed in Japanese Patent Application Laid-Open No. 2016-012130 and Japanese Patent Application Laid-Open No. 2020-008847 have surfaces with a lower friction and an improved durability due to the high-hardness acrylic resin thereof, but have a reduced toner rolling ability and poor triboelectricity-imparting performance. Specifically, for example, when they are used in a low-temperature, low-humidity environment (hereinafter may be referred to as an “L/L environment”) at a temperature of 15° C. and a relative humidity of 10%, the flexibility of the developing member decreases, and thus the toner rolling ability decreases, resulting in insufficient charge on the toner surface.

When charge is insufficient on the toner surface, there is a risk of occurrence of image defects such as fogging on white backgrounds. In addition, for example, when they are used in a high-temperature, high-humidity environment (hereinafter may be referred to as an “H/H environment”) at a temperature of 30° C. and a relative humidity of 80%, the surface of the developing member becomes soft, and thus strong friction occurs at a contact part with the photoreceptor, which may cause fracture on the surface of the developing member.

### SUMMARY

The present disclosure provides a developing member that appropriately charges toner in a low-temperature, low-humidity environment and has excellent scratch resistance even when used over a long period of time in a high-temperature, high-humidity environment. Also, the present disclosure provides an electrophotographic process cartridge and an electrophotographic image forming apparatus that contribute to stable formation of high-quality electrophotographic images.

The present disclosure relates to a developing member comprising: a surface comprised a resin comprising an acrylic structure and a urethane structure, wherein when a sum of carbon atoms, oxygen atoms, and nitrogen atoms detected by X-ray photoelectron spectroscopy on the surface is used as a reference, a proportion of the nitrogen atoms is defined as N1 (atomic %), a proportion of the oxygen atoms forming an ether structure is defined as O1 (atomic %), a proportion of carbon atoms that are not carbon atoms forming a carbonyl structure among the carbon atoms adjacent to oxygen is defined as C1 (atomic %), and a proportion of carbon atoms forming the carbonyl structure in the acrylic structure is defined as C2 (atomic %), the N1, O1, C1, and C2 satisfy formulas (A) to (C) below: 1.08≤N1 . . . (A); 20.0≤O1/N1≤39.8 . . . (B); and 4.10≤C1/C2≤6.90 . . . (C).

Additionally, the present disclosure relates to a process cartridge configured to be detachably attached to a main body of an electrophotographic image forming apparatus, the process cartridge comprising: the above-mentioned developing member.

In addition, the present disclosure relates to an electrophotographic image forming apparatus comprising: the above-mentioned developing member.

Features of the present disclosure will become apparent from the following description of embodiments with reference to the attached drawings. The following description of embodiments is described by way of example.

### BRIEF DESCRIPTION OF THE DRAWINGS

FIGS. 1A to 1C are schematic cross-sectional views of an example of an electrophotographic roller.

FIG. 2 is a schematic configuration diagram of an example of a process cartridge.

FIG. 3 is a schematic cross-sectional view of an example of an electrophotographic apparatus.

### DESCRIPTION OF THE EMBODIMENTS

In the present disclosure the notations “from XX to YY” and “XX to YY” representing a numerical value range signify, unless otherwise specified, a numerical value range that includes the lower limit and the upper limit of the range, as endpoints. In a case where numerical value ranges are described in stages, the upper limits and the lower limits of the respective numerical value ranges can be combined arbitrarily. In the present disclosure, for instance, a wording such as “at least one selected from the group consisting of XX, YY and ZZ” encompasses XX, YY and ZZ, a combination of XX and YY, a combination of XX and ZZ, a combination of YY and ZZ, and a combination of XX, YY and ZZ. In the case where XX represents a group, a plurality of members may be selected from XX, and the same is true for YY and ZZ.

The inventors conducted extensive studies to obtain a developing member that appropriately charges toner even in an L/L environment and has excellent scratch resistance when used over a long period of time. First, the inventors conducted tests on the charge imparting property in an L/L environment with respect to the developing member disclosed in Japanese Patent Application Laid-Open No. 2016-012130 and a developing member that does not include an acrylic structure, and confirmed that the developing member disclosed in Japanese Patent Application Laid-Open No. 2016-012130 has a lower toner charge on the developing member than the developing member that does not include an acrylic structure. From this, the inventors inferred that, due to low tackiness of the acrylic structure, toner slides on a surface of the developing member, and thus only specific portions on the toner can be charged, and sufficient charging cannot be obtained.

In contrast, the developing member that does not include the acrylic structure allows toner to roll rather than slide, and thus frictional charging is sufficiently imparted throughout the toner. However, the developing member that does not include the acrylic structure has high tackiness, which causes strong friction at an abutting portion with a photoreceptor outside a toner-coated region, resulting in fracture of a surface of the developing member. In addition, the inventors consider that a surface structure in which flexible segments and hard segments are finely distributed predominantly on a member surface is useful for a developing member for sufficiently rolling toner and enabling usage over a long period of time.

Based on the above considerations, the inventors conducted further studies and found that a developing member having the following configurations contributes to solving the above-described problems:
A resin forming a surface layer including an acrylic structure and a urethane structure
A resin forming a surface layer having a segment having high molecular mobility
A resin forming a surface layer having a structure with oxygen-adjacent carbon atoms and containing sufficiently oxygen-adjacent carbon atoms that are not constituent carbon atoms of a carbonyl group structure.

That is, when the sum of carbon atoms, oxygen atoms, and nitrogen atoms detected by X-ray photoelectron spectroscopy on a surface of a developing member is used as a reference, a proportion of the nitrogen atoms is defined as N1 (atomic %), a proportion of the oxygen atoms forming an ether structure is defined as O1 (atomic %), a proportion of carbon atoms that are not carbon atoms forming a carbonyl structure among the carbon atoms adjacent to oxygens is defined as C1 (atomic %), and a proportion of carbon atoms forming the carbonyl structure in the acrylic structure is defined as C2 (atomic %).

In this case, N1, O1, C1, and C2 satisfy the following formulas (A) to (C).

1.08≤N1 (A)

20.0≤O1/N1≤39.8 (B)

4.10≤C1/C2≤6.90 (C).

As to the reason why the developing member configured as described above maintains an appropriate charge quantity and is less likely to cause fogging even in an L/L environment, the inventors have inferred as follows.

As the structure that has a segment with high molecular mobility, has a structure with oxygen-adjacent carbons, and sufficiently contains oxygen-adjacent carbons that are not constituent carbons of a carbonyl group, for example, an ether structure at a polymer chain terminal (hereinafter, sometimes referred to as a “terminal ether group-containing structure”) is conceivable. Such a terminal ether structure may be present at terminals of a main chain and a side chain of a polymer chain. The terminal ether group-containing structure is, for example, a side chain structure containing an ether group at its terminal.

The terminal ether group-containing structure has high molecular mobility and is thus expected to be oriented and localized on an outermost surface of a resin. Localization of the ether structure on the outermost surface of the resin locally improves the resin's flexibility and increases the dynamic friction coefficient. In addition, since the terminal ether group-containing structure contains oxygen atoms, it is expected to form a hydrogen bond with the protic hydrogen contained in the urethane bond.

Urethane resins have domains with low flexibility, called hard segments, due to hydrogen bonding between urethane bonds and, in particular, stacking effects in structures containing aromatic rings in their composition, such as polymeric MDI. Due to these interactions, it is conceivable that the surface-oriented terminal ether group-containing structure (high tack portion) and the urethane structure (low tack portion), which is a hard segment, form a network.

With such a network, the low tack portion and the high tack portion can be finely distributed on the outermost surface of the resin, and thus it is conceivable that, even in a resin containing a high-hardness acrylic structure, toner can be caused to roll favorably. In addition, since nitrogen atoms constituting the urethane structure have a high charge imparting property, surface orientation of the urethane structure increases the proportion of nitrogen present near the resin surface, improving the charging performance of the developing member.

The developing member that satisfies the configurations of the above-described formulas (A), (B), and (C) exhibits the above effects. However, for example, a member that does not satisfy Formula (A), such as that in which N1 is less than 1.08, has a low amount of nitrogen present on a surface of a developing member, and thus it has a low charge imparting property for toner and is unable to sufficiently charge the toner. For that reason, fogging is likely to occur in an L/L environment.

N1 is, for example, 1.08 to 1.50, preferably 1.12 to 1.40, and more preferably 1.19 to 1.35.

N1 can be controlled, for example, by changing a blending ratio of isocyanate to polyol used as raw materials, or, when a prepolymer-type isocyanate is used, by selecting materials having different cross-linking densities due to urethane bonds of the prepolymer.

Also, in Formula (B), O1/N1 represents a ratio of terminal ether group-containing structures to urethane bonds. As will be described later in the description of ESCA measurement, O1 reflects oxygen atoms forming ether bonds. If O1/N1 is less than 20.0, there is less oxygen originating from the terminal ether group-containing structures relative to the nitrogen originating from the urethane bonds, and thus fine distribution of segments that improve surface flexibility, such as the terminal ether group-containing structures, is insufficient. For that reason, the toner rolling ability is inadequate, and a charge quantity of the toner is insufficient. For that reason, fogging is likely to occur in an L/L environment.

In Formula (C), C1/C2 represents a ratio of carbon with high molecular mobility to carbonyl in the acrylic structure. As will be described later in the description of ESCA measurement, C2 is a numerical value excluding carbonyl carbon originating from urethane bonds and represents a proportion of carbonyl carbon in the acrylic structure. The carbon reflected in C2 includes, for example, carbon in ester bonds contained in the cross-linked acrylic resin.

In the configuration in which C1/C2 is less than 4.10, a ratio of flexible segments such as the terminal ether group-containing structure to the acrylic component on the outermost surface is insufficient, which causes poor charging due to insufficient rolling of the toner. For that reason, fogging is likely to occur in an L/L environment.

In addition, it was found that the developing member having the above configuration has high scratch resistance even when used over a long period of time. It is conceivable that satisfying the above formulas (A), (B), and (C) in the developing member having the surface made of the resin containing the acrylic structure and the urethane structure indicates the following states. First, in addition to the presence of the acrylic structure on the surface of the developing member, when the terminal ether group-containing structure is oriented on the surface, the urethane structure, which is a hard segment, is likely to be disposed near the surface due to the hydrogen bond network, resulting in low tackiness.

In such a configuration, in the configuration in which O1/N1 in Formula (B) is greater than 39.8, the flexible segments distributed at the surface are in excess compared with the hard segments formed by the urethane structure. For that reason, it is conceivable that the dynamic friction coefficient of the surface of the developing member increases, leading to fracture of the member surface.

Further, in the configuration in which C1/C2 in Formula (C) is greater than 6.90, the acrylic components at the surface of the developing member are insufficient for the flexible segments represented by the terminal ether group-containing structure. For that reason, it is conceivable that the tack reduction effect of the acrylic component is not fully achieved, leading to fracture of the member surface.

Also, when the resin of the developing member does not contain an acrylic structure and C2 is not detected, the tack reduction effect is similarly not fully achieved, resulting in fracture of the member surface.

O1/N1 is preferably 25.0 to 39.8, more preferably 28.0 to 38.5, and even more preferably 29.0 to 34.0. Within the above range, fog suppression and scratch resistance are likely to be achieved. O1/N1 can be controlled, for example, by adding a monool having ether bonds and changing its blending ratio or controlling its molecular weight.

C1/C2 is preferably 5.00 to 6.90, more preferably 5.30 to 6.80, and even more preferably 5.40 to 6.80. Within the above range, fog suppression and scratch resistance are likely to be achieved. C1/C2 can be controlled, for example, by adding an acrylic polyol and changing its blending ratio or controlling its molecular weight.

The developing member satisfying the configurations of Formulas (A), (B), and (C) can cause the toner to roll favorably and charge it appropriately, and can suppress the fracture of the member even when used over a long period of time due to a low dynamic friction coefficient. It is conceivable that the above configuration effectively exhibits its function in a region of the surface layer near the outermost surface, approximately 0.1 μm deep from the outermost surface.

Preferred embodiments of the present disclosure will be described in detail below with reference to the drawings. Constituent members, materials, shapes, their relative arrangements, and the like described in these embodiments do not limit the scope of the present disclosure.

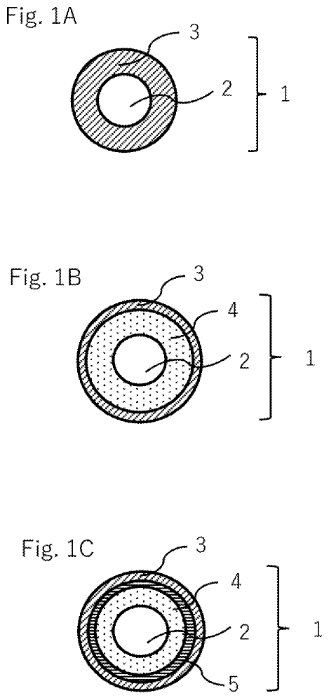

A developing member according to an embodiment of the present disclosure includes, for example, a conductive base, and a surface layer on the base. For example, a surface of the surface layer is made of a resin containing an acrylic structure and a urethane structure. As an example of the developing member, a roller-shaped developing member (developing roller) is shown in FIGS. 1A to 1C.

A developing member 1 shown in FIG. 1A is configured of a conductive base 2, and a surface layer 3 made of a conductive layer disposed at an outer circumference thereof. As shown in FIG. 1B, an elastic layer 4 may be provided between the base 2 and the surface layer 3. In addition, as shown in FIG. 1C, the developing member 1 may have a three-layer structure in which an intermediate layer 5 is further disposed between the elastic layer 4 and the surface layer 3, or may have a multi-layer structure in which a plurality of intermediate layers 5 are disposed. The surface layer 3 may be a resin layer made of a conductive resin.

Also, the layer configuration of the developing member 1 is not limited to the configuration shown in FIGS. 1A to 1C. The developing member 1 may have a surface layer formed by laminating one or more other resin layers or protective layers on the outer circumference of the conductive layer, such as a configuration in which a surface layer is further provided on the base 2 and the conductive layer formed on the outer circumference of the base 2. Further, a configuration in which the conductive layer is provided as the intermediate layer 5 may be adopted. The outermost surface of the developing member 1 may be made of the resin containing the acrylic structure and the urethane structure.

Among these, in order to further enhance the effects of the present disclosure, the developing member of the present disclosure preferably has a configuration in which the conductive layer is the surface layer 3, as shown in FIGS. 1A to 1C. That is, the developing member preferably has the conductive layer on the outermost surface of the developing member. Further, the developing member 1 preferably has the elastic layer 4.

A configuration of the developing member according to one embodiment of the present disclosure will be described in detail below.

### <Surface Layer>

The surface layer may form, for example, the outermost surface of the developing member, and may form a surface made of a resin containing the acrylic structure and the urethane structure. The surface layer is made of, for example, the resin containing the acrylic structure and the urethane structure. From the viewpoint of conductivity and tack reduction, the developing member (for example, the surface layer) preferably contains carbon black dispersed in the resin containing the acrylic structure and the urethane structure. The resin containing the acrylic structure and the urethane structure may serve as a binder resin. Also, the resin (for example, the surface layer) on the surface of the developing member preferably contains a cross-linked urethane resin that forms the urethane structure and a cross-linked acrylic resin that forms the acrylic structure.

A thickness of the surface layer is not particularly limited, but is preferably 2 to 150 μm, more preferably 5 to 100 μm, and even more preferably 8 to 20 μm. In the case of at least the lower limit, set marks caused by prolonged abutment with a control member are likely to be suppressed. In addition, in the case of not more than the above upper limit, filming caused by toner stress is likely to be suppressed.

At least 80% by mass of the resin formed in a region from the outermost surface of the developing member to a depth of 0.1 μm is preferably the resin containing the acrylic structure and the urethane structure. The content is preferably 80 to 100% by mass, 85 to 98% by mass, or 85 to 92% by mass. When the content is within the above range, fog suppression and scratch resistance are likely to be achieved.

### [Cross-Linked Urethane Resin]

The cross-linked urethane resin is obtained by reacting a polyol containing a hydroxyl group and an isocyanate compound to form a urethane group. The term “cross-linked” here indicates that one or both selected from the group consisting of a polyol and an isocyanate compound, which are raw materials of a urethane resin, have three or more reactive functional groups, thereby having a three-dimensional mesh structure. Such a cross-linked urethane resin has excellent flexibility and high strength.

The urethane resin can be obtained from a polyol and an isocyanate compound, and a chain extender, if needed. Examples of the polyol, which is a raw material of the urethane resin, include a polyether polyol, a polyester polyol, a polycarbonate polyol, a polyolefin polyol, an acrylic polyol, and mixtures thereof.

Examples of the isocyanate compound, which is a raw material of the urethane resin, include the following compounds.

Tolylene diisocyanate (TDI), diphenylmethane diisocyanate (MDI), polymethylene polyphenylene polyisocyanate (polymeric MDI), naphthalene diisocyanate (NDI), tolidine diisocyanate (TODI), hexamethylene diisocyanate (HDI), isophorone diisocyanate (IPDI), phenylene diisocyanate (PPDI), xylylene diisocyanate (XDI), tetramethylxylylene diisocyanate (TMXDI), cyclohexane diisocyanate, and mixtures thereof.

Among them, the polyol preferably contains a polyether polyol. The polyether polyol provides flexibility even in an L/L environment due to a low elastic modulus at low temperature, resulting in excellent toner rolling ability. In addition, it exhibits excellent compatibility when a material containing the terminal ether group-containing structure is blended.

Further, from the viewpoint of improvement of reactivity due to electrophilicity originating from a resonance structure of an aromatic ring and formation of hard segments due to a stacking effect of the aromatic ring, the resin containing the acrylic structure and the urethane structure preferably contains an aromatic urethane structure. Accordingly, the isocyanate compound is preferably an aromatic isocyanate such as TDI or MDI, and more preferably polymeric MDI.

Here, polymeric MDI is a mixture of monomeric MDI and a high molecular weight polyisocyanate, and is represented by the following formula (A). In Formula (A), n is preferably from 0 to 4.

As the polymeric MDI, a commercially available product may be used, and examples thereof include Millionate MR series (manufactured by Tosoh Corporation) such as Millionate MR200 (product name).

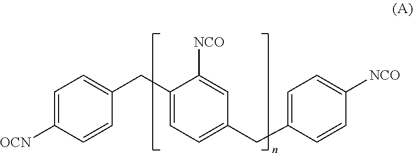

Examples of the chain extender, which is an arbitrary component, include bifunctional low molecular weight diols such as ethylene glycol, 1,4-butanediol, and 3-methylpentanediol, trifunctional low molecular weight triols such as trimethylolpropane, and mixtures thereof. In addition, a prepolymer-type isocyanate compound having an isocyanate group at its terminal may be used, which is obtained by reacting the above various isocyanate compounds with various polyols in a state in which isocyanate groups are in excess relative to a hydroxyl group in advance. Also, as these isocyanate compounds, materials obtained by blocking isocyanate groups with various blocking agents such as methyl ethyl ketone (MEK) oxime may be used.

When any of the materials is used, a urethane resin can also be obtained by reacting a polyol and an isocyanate compound by heating. Any one or both of the polyol and the isocyanate compound have a branched structure and three or more functional groups, and thus the resultant urethane resin becomes a cross-linked urethane resin, which is preferable.

It is preferable that the cross-linked urethane resin contain a polyol and an isocyanate compound, one or both selected from the group consisting of polyols and isocyanate compounds are reactants of a urethane raw material having 3 or more reactive functional groups. The urethane raw material preferably contains a polymer compound capable of forming a structure represented by the following structural formula (1) and/or (2). The polymer compound facilitates formation of the terminal ether group-containing structure.

The resin forming the surface of the developing member preferably includes the structure represented by the following structural formula (1). For example, when the cross-linked urethane resin has the structure represented by the following structural formula (1) at its terminal, the structure represented by the formula (1) is likely to orient toward the outermost surface of the surface layer due to the high molecular mobility, and the above-mentioned network by hydrogen bonds is likely to be formed. For that reason, fog suppression and scratch resistance are likely to be achieved.

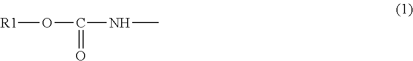

R1 is, for example, an organic group that causes the number-average molecular weight (Mn) of a portion of the structure represented by the structural formula (1) to be 500 to 3500, and preferably 500 to 2500. The organic group contains an oxyalkylene structure. The organic group preferably has no cyclic structure. The carbon number of an alkylene group in the oxyalkylene structure is preferably 1 to 6, and more preferably 2 to 4.

Also, the structure represented by the structural formula (1) is preferably the structure represented by the following structural formula (2). That is, the resin forming the surface of the developing member preferably includes the structure represented by the following structural formula (2). The structure represented by the following structural formula (2) is more preferable because it has a branched alkylene structure with high molecular mobility and a linear alkylene structure with high polarity and surface orientation.

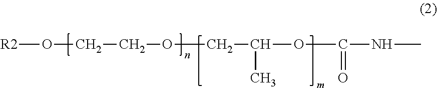

In the structural formula (2), R2 represents a linear or branched alkyl group with carbon number of 1 to 6 (preferably 2 to 6). m and n independently represent an integer of 1 or greater, which results in the number-average molecular weight Mn of 500 to 3500, preferably 500 to 2500, of the structure represented by the structural formula (2). The arrangement of the ethylene oxide structures in parentheses followed by n and the propylene oxide structures in parentheses followed by m may be block polymerized or random polymerized.

The structure of the structural formula (1) and/or (2) can be introduced into the urethane structure (preferably the cross-linked urethane resin) by the following method, for example.

A polymer compound that has one terminal hydroxyl group, preferably has no cyclic structure, and may form the structure of the structural formula (1) and/or (2) is added to a cross-linked urethane resin forming material and heated to react terminal isocyanate groups of polyurethane with hydroxyl groups of the compound to form urethane bonds. Examples of the polymer compound that may form the structures of the structural formula (1) and/or (2) include, for example, structures in which —NH—CO— is replaced by —H in the structure of the formula (1) and/or (2).

Examples of the polymer compound having one hydroxyl group at the terminal include monools which have an oxyalkylene structure in the molecule and do not contain a cyclic structure.

Specific examples include, for example, poly(oxyalkylene) glycol monoethers in the “Newpol” (registered trademark) series manufactured by Sanyo Chemical Industries, Ltd. More specifically, “Newpol 50HB-100” (monool (poly(oxyethyleneoxypropylene) glycol monobutyl ether), Mn=510), “Newpol 50HB-660” (monool (poly(oxyethyleneoxypropylene) glycol monobutyl ether), Mn=1800), “Newpol LB-1715” (monool (polyoxypropylene monobutyl ether), Mn=2390), and “Newpol 50HB-2000” (monool (poly(oxyethyleneoxypropylene) glycol monobutyl ether), Mn=3200) can be exemplified.

A containing proportion of the structure represented by the structural formula (1) (preferably the structure represented by the structural formula (2)) in the resin containing the acrylic structure and the urethane structure that form the surface of the developing member is, for example, 0.5 to 15.0% by mass, preferably 1.0 to 10.0% by mass, and more preferably 2.5 to 8.0% by mass.

### [Cross-Linked Acrylic Resin]

The cross-linked acrylic resin may form the acrylic structure that forms the surface of the developing member. The cross-linked acrylic resin usually has high strength, but when used alone, sufficient charging cannot be obtained, and fogging is likely to occur. On the other hand, by causing it to be present in the resin of the surface together with the urethane structure, the toner is caused to roll favorably, thereby improving the charging performance. By incorporating an acrylic modified monomer into the urethane structure, the cross-linked acrylic resin is formed to collapse the crystallinity, and thus plastic deformation is suppressed, and scratches are hardly formed.

Accordingly, the urethane raw material preferably contain the acrylic-modified monomer that forms the cross-linked acrylic resin. A surface layer forming raw material for forming the resin forming the surface of the developing member is, for example, a mixture of a urethane raw material forming the cross-linked acrylic resin and an acrylic modified monomer forming the cross-linked acrylic resin. By reacting the surface layer forming raw material, a surface made of the resin containing the acrylic structure and the urethane structure may be formed.

Examples of the compound (acrylic-modified monomer) as the raw material of the cross-linked acrylic resin include the following.

Examples include: (meth)acrylates having alkyl groups, such as methyl (meth)acrylate, ethyl (meth)acrylate, propyl (meth)acrylate, n-butyl (meth)acrylate, iso-butyl (meth)acrylate, t-butyl (meth)acrylate, n-pentyl (meth)acrylate, and n-hexyl (meth)acrylate; (meth)acrylates having alicyclic hydrocarbon groups, such as cyclopentyl (meth)acrylate and cyclohexyl (meth)acrylate; and polymer materials having an acrylic structure, such as acrylic-modified urethane material, acrylic-modified silicone material, and acrylic-modified epoxy resin material.

Among them, the acrylic-modified urethane material is preferable since the acrylic-modified monomer copolymerizes with the above-described cross-linked urethane resin, and acrylic polyol is more preferable.

The acrylic polyol is preferably a polymer of an acrylic monomer containing a (meth)acrylate having a hydroxyl group. Specific examples of the (meth)acrylate having a hydroxyl group include hydroxy esters of (meth)acrylic acid, such as hydroxymethyl (meth)acrylate, hydroxyethyl (meth)acrylate, hydroxypropyl (meth)acrylate, and hydroxybutyl (meth)acrylate. These can also be used in mixtures.

Further, the acrylic monomer is preferably a lactone-modified (meth)acrylate obtained by reacting a lactone (for example, with carbon number of 2 to 10, preferably 4 to 8) with a (meth)acrylate having a hydroxyl group. Lactone-modified acrylic polyol, which is a polymer of an acrylic monomer containing a lactone-modified (meth)acrylate, is preferably used because of excellent reactivity due to its polarity. A copolymer of a lactone-modified (meth)acrylate and styrene can be particularly preferably used because it not only has excellent reactivity but also increases the rigidity of the resin due to the interaction between aromatic rings. The (meth)acrylate having a hydroxyl group is preferably a hydroxy ester of (meth)acrylic acid.

The acrylic polyol is more preferably a lactone-modified acrylic polyol, which is a polymer of an acrylic monomer including a lactone-modified (meth)acrylate and styrene. A content of a structure obtained by polymerization of styrene in the lactone-modified acrylic polyol is, for example, 20 to 80% by mass, and preferably 40 to 60% by mass. Also, a content of a structure obtained by polymerization of the lactone-modified (meth)acrylate in the lactone-modified acrylic polyol is, for example, 20 to 100% by mass, preferably 20 to 80% by mass, and more preferably 40 to 60% by mass.

A hydroxyl value of the acrylic polyol is, for example, 50 to 200 mgKOH/g, and preferably 70 to 140 mgKOH/g.

The resin containing the acrylic structure and the urethane structure that form the surface of the developing member preferably includes the structure represented by the following structural formula (3).

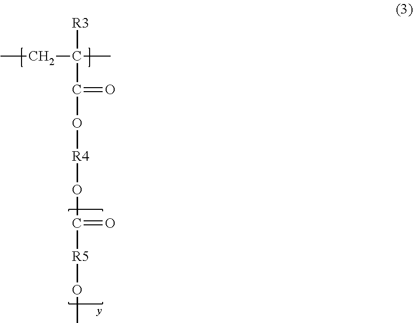

In the structural formula (3), y represents an integer of 1 or greater, R3 represents a hydrogen atom or a methyl group, R4 represents a methylene group with carbon number of 2 to 4 (preferably 2 or 3), and R5 represents a methylene group with carbon number of 2 to 8 (preferably 4 to 6).

The structural formula (3) indicates a state in which a lactone-modified acrylic polyol as a cross-linked acrylic resin is incorporated into a urethane resin. The structure in the parentheses with y is a structure formed by the reaction of lactone, and the terminal in the parentheses with y may form a urethane bond, which is a bonding site with the cross-linked urethane resin. The structure in the parentheses with R3 is a poly (meth) acrylic structure.

y is preferably 1 to 15, and more preferably 3 to 10.

The resin containing the acrylic structure and the urethane structure that form the surface of the developing member preferably contains a structure represented by the following structural formula (4). Formula (4) is a structure obtained by polymerization of styrene. In the resin containing the acrylic structure and the urethane structure that form the surface of the developing member, the structure of Formula (3) and the structure of Formula (4) are preferably randomly polymerized as the cross-linked acrylic resin.

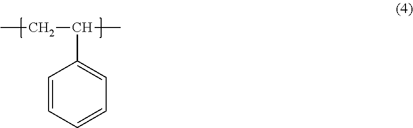

A content of the structural formula (3) in the cross-linked acrylic resin is, for example, 20 to 100% by mass, preferably 20 to 80% by mass, and more preferably 40 to 60% by mass. A content of the structural formula (4) in the cross-linked acrylic resin is, for example, 20 to 80% by mass, and preferably 40 to 60% by mass.

A content of the structural formula (3) in the resin containing the acrylic structure and the urethane structure that form the surface of the developing member is, for example, 0.1 to 5.0% by mass, preferably 0.1 to 2.0% by mass, and more preferably 0.2 to 1.0% by mass. Further, a content of the structural formula (4) in the resin containing the acrylic structure and the urethane structure that form the surface of the developing member is, for example, 0.1 to 2.0% by mass, and preferably 0.2 to 1.0% by mass.

### [Conductive Material]

The surface layer preferably has electrical conductivity. Examples of the means for imparting conductivity include addition of an ionic conductive agent or conductive fine particles. Conductive fine particles are preferred because they are inexpensive and exhibit little environmental change in resistance, and carbon black is particularly preferred from the viewpoint of conductivity imparting and reinforcing properties.

The developing member preferably contains carbon black, and more preferably, the surface layer of the developing member contains carbon black.

If the conductive fine particles have properties of a primary particle diameter from 16 nm to 50 nm, a DBP oil absorption from 50 ml/100 g to 160 ml/100 g, and are acidic carbon black, they provides a good balance of conductivity, hardness, and dispersibility, which is preferable.

As the carbon black, specifically, conductive carbon blacks such as Ketjen Black (product name; manufactured by Lion Corporation) and acetylene black; rubber carbon blacks such as SAF, ISAF, HAF, FEF, GPF, SRF, FT, and MT; and other carbon blacks such as oxidation-treated color ink carbon black and pyrolytic carbon black can be used. These can be used alone or in combination of two or more.

From the viewpoint of further increasing the breaking strength of the resin forming the surface layer and preventing charge leakage of charged toner, a content of the carbon black added to the surface layer is, for example, 20 to 40 parts by mass, and preferably 25 to 35 parts by mass, per 100 parts by mass of the resin forming the surface layer. Since the acidic carbon black interacts with isocyanate, dispersibility of a coating material or coating film in the surface layer can be improved and nitrogen atoms can be appropriately distributed. If the content is as above, the surface layer of the developing member is less likely to break, and leakage of charge of the toner through the developing member is likely to be suppressed.

In addition to the above carbon black, as usable conductive agents, the following can be exemplified. Examples include: natural or artificial graphite; metal powder such as copper, nickel, iron, and aluminum; metal oxide powder such as titanium oxide, zinc oxide, and tin oxide; and conductive polymers such as polyaniline, polypyrrole, and polyacetylene. These can be used alone or in combination of two or more as needed.

### Other Components

In addition to the above, the surface layer may contain conductive materials, cross-linking agents, plasticizers, fillers, extenders, vulcanizing agents, vulcanization aids, cross-linking aids, oxidation inhibitors, antioxidants, processing aids, leveling agents, and the like, provided that the functionality of the surface layer is not impaired. In addition, if surface roughness is required on the surface layer, fine particles for imparting roughness may be contained in the surface layer. Specifically, the fine particles of a polyurethane resin, a polyester resin, a polyether resin, a polyamide resin, a (meth)acrylic resin, or a polycarbonate resin can be used. A volume average particle diameter of the fine particles is preferably from 1.0 μm to 30 μm, and a surface roughness (ten-point average roughness) Rzjis formed by the fine particles is preferably from 0.1 μm to 20 μm. Also, Rzjis is a value measured in accordance with JISB0601 (1994).

The surface layer preferably contains fine particles for imparting roughness. Examples of a content of the fine particles for imparting roughness to the surface layer include, for example, 1 to 20 parts by mass, or 3 to 15 parts by mass, per 100 parts by mass of the resin containing the acrylic structure and the urethane structure.

### <Base>

The conductive base 2 functions as an electrode and a support member of the electrophotographic member 1. The base is comprised of, for example, a conductive material such as a metal or an alloy, such as aluminum, a copper alloy, or stainless steel; iron plated with chromium or nickel; or a conductive synthetic resin.

Also, a primer may be applied to a surface of the base in order to improve adhesion between the base and the elastic layer, which will be described later. As an example of the primer, a silane coupling agent-based primer, or a urethane-based, an acrylic-based, a polyester-based, a polyether or epoxy-based thermosetting resin or thermoplastic resin can be used. A commercially available primer includes the following: “DY39-051,” “DY39-012,” “DY39-115” (all product names, manufactured by Dow Corning Toray Co., Ltd.); “X-33-173,” “PRIMER-NO. 4,” “PRIMER-NO. 32,” “PRIMER-NO. 35” (all product names, manufactured by Shin-Etsu Chemical Co., Ltd.) “XP81-405,” “XP81-A6361,” “XP81-B7015,” “ME21,” “ME151,” “ME153,” and “XC9214” (all product names, manufactured by Momentive Performance Materials Japan, LLC).

A known alkoxysilane, a titanate ester, or the like may be added to the primer in order to improve the adhesion. Specific examples of the alkoxysilane and the titanate include tetramethoxysilane, tetraethoxysilane, tetra-n-butoxysilane, tetraethoxytitanium, tetraisopropoxytitanium, and tetra-n-butoxytitanium, and the like. These are preferably added in an amount of 0.1 to 20 parts by mass per 100 parts by mass of the primer.

### <Elastic Layer>

If the developing member has a roller shape, that is, if it is a developing roller, the elastic layer 4 has a function of providing the developing member 1 with elasticity required for forming a nip having a predetermined width at the abutting portion between the developing member 1 and the photoreceptor. The elastic layer 4 is preferably a molded body made of a rubber material.

As the rubber material, various rubber materials typically used in conductive rubber rollers can be used. Specific examples of rubber using for the rubber materials include ethylene-propylene-diene copolymer rubber (EPDM), acrylonitrile-butadiene rubber (NBR), chloroprene rubber (CR), natural rubber (NR), isoprene rubber (IR), styrene-butadiene rubber (SBR), fluororubber, silicone rubber, epichlorohydrin rubber, NBR hydride, polysulfide rubber, urethane rubber, and the like. These may be used alone or in combination of two or more. Amont these, silicone rubber is particularly preferred from the viewpoint of stability against deformation such as setting performance.

Examples of the silicone rubber include polydimethylsiloxane, polymethyltrifluoropropylsiloxane, polymethylvinylsiloxane, polyphenylvinylsiloxane, and copolymers of these polysiloxanes.

Examples of dimethylpolysiloxane used for the silicone rubber include, for example, SF3000SE and SP6000P (both product names, manufactured by KCC Corporation).

Various additives such as a conductivity imparting agent, a non-conductive filler, a cross-linking agent, and a catalyst may be appropriately blended in the elastic layer 4. As the conductivity imparting agent, carbon black; conductive metals such as aluminum and copper; and fine particles of conductive metal oxides such as zinc oxide, tin oxide, and titanium oxide can be used. Among these, carbon black is preferred because it provides good conductivity at relatively low addition amounts.

Further, as the non-conductive filler, silica, quartz powder, titanium oxide, zinc oxide, calcium carbonate, or the like can be exemplified. As the cross-linking agent, di-t-butyl peroxide, 2,5-dimethyl-2,5-di(t-butylperoxy)hexane or dicumyl peroxide can be exemplified. As the catalyst, a platinum-based catalyst, a rhodium-based catalyst, or a palladium-based catalyst can be exemplified, and the platinum-based catalyst is particularly preferred.

The elastic layer 4 may be configured of a plurality of layers. Also, the intermediate layer 5 may be provided between the base 2 and the elastic layer 4 or between the elastic layer 4 and the surface layer 3. A thickness of the elastic layer 4 is preferably 0.25 to 8.00 mm, and more preferably 0.30 to 3.00 mm.

<<Developer Amount Control blade>>

A developer amount control blade according to another aspect of the present disclosure will be described.

The developer amount control blade controls an amount of a developer discharged from a developer container by a developer carrying member and has at least a support member and a blade member, in which the blade member is made of a thermoplastic elastomer composition containing a block copolymer having a polyamide structure and a polyether structure, and an ion conductive agent, and is formed on the support member.

For the blade member, a thermoplastic elastomer composition containing a block copolymer containing a polyamide structure and a polyether structure is used, in which an ionic conductive agent is dispersed so that the volume resistivity is in the medium resistance range of about from 1.0×10⁵ Ω·cm to 5.0×10⁸ Ω·cm. By using the thermoplastic elastomer composition containing a block copolymer having a polyether structure in its backbone, ions such as metal salts can be stabilized in the blade member, and the electrical resistance of the blade member can be effectively reduced. In addition, since the block copolymer contains a polyamide structure, it has excellent triboelectric charging capability with respect to the toner.

Examples of the polyamide structure of the block copolymer containing a polyamide structure and a polyether structure include the following. Polyamide structures composed of repeating units containing amide bonds, such as nylon 6 repeating units, nylon 6·6 repeating units, nylon 6·10 repeating units, nylon 6·12 repeating units, nylon 12 repeating units, and nylon 12.12 repeating units. Among these polyamide structures, a polyamide structure containing nylon 12 repeating units is particularly preferred.

The polyether structure is, for example, a structure represented by —[(CH₂)₂O]ₙ—. Here, n represents an integer of 1 or greater. Specific examples of the block copolymer containing a polyamide structure and a polyether structure include, for example, “Pelestat N1200” (product name; manufactured by Sanyo Chemical Industries, Ltd.) and “diamide E40-S4” (product name; manufactured by Daicel Evonik Co.).

A thickness of the blade member is not particularly limited, but is, for example, from 10 μm to 1000 μm on an abutment support surface of the support member. If the thickness of the blade member on the abutment support surface of the support member is 10 μm or more, durability against wear due to friction with the developer carrying member can be secured, and if the thickness is 1000 μm or less, a stable abutting pressure with the developer carrying member can be obtained.

Structural analysis of the polyamide structure and the polyether structure in the block copolymer forming the blade member can be performed using infrared absorption spectroscopy, nuclear magnetic resonance spectroscopy, or the like.

The ionic conductive agent forming the blade member can be detected by extracting the blade member with water, and then using time-of-flight secondary ion mass spectrometry (TOF-SIMS) and infrared absorption spectroscopy.

Examples of the ionic conductive agent include the following. Perchlorates, chlorates, hydrochlorides, bromates, iodates, borofluids, sulfates, alkyl sulfates, carboxylates, and sulfonates of ammonium, such as tetraethylammonium, tetrabutylammonium, lauryltrimethylammonium, dodecyltrimethylammonium, stearyltrimethylammonium, octadecyltrimethylammonium, hexadecyltrimethylammonium, benzyltrimethylammonium, and modified aliphatic dimethylethylammonium; perchlorates, chlorates, hydrochlorides, bromates, iodates, hydroborate fluorosulfates, trifluoromethanesulfonates, trifluoromethanesulfonates, sulfonates, alkylbenzenesulfonates, and bis(trifluoromethanesulfonic acid)imide salts of alkali metals or alkaline earth metals, such as lithium, sodium, calcium, and magnesium; 1,1,2,2,3,3-hexafluoropropane-1,3-disulfonyl difluoride, and the like. Among them, trifluoromethanesulfonates, trifluoromethanesulfates, and bis(trifluoromethanesulfonic acid)imide salts of alkali metals are preferred. These salts are suitable because they have a structure in which the anion contains fluorine, thereby providing a significant conductivity imparting effect. It is particularly preferred that the ionic conductive agent has a trifluoromethane moiety. One type of ionic conductive agent may be used, or two or more types may be used in combination.

A content of the ionic conductive agent is not particularly limited, but is preferably from 0.01 parts by mass to 2.00 parts by mass per 100 parts by mass of the block copolymer containing a polyamide structure and a polyether structure, and more preferably from 0.10 parts by mass to 1.00 parts by mass. Thus, a volume resistivity of the thermoplastic elastomer composition can be easily adjusted to from 1.0×10⁵ Ω·cm to 5.0×10⁸ Ω·cm, and the blade member having little variation in electrical resistance in the medium resistance region can be more easily obtained.

As a material of the support member, a metal or a resin may be used. Specifically, metals such as stainless steel, phosphor bronze, and aluminum, or resins such as polyethylene terephthalate, acrylic resin, polyethylene, and polyester can be exemplified. It is preferable to add a conductive material to such a resin in order to obtain desired conductivity.

A shape of the support member is preferably a flat plate shape or a curved plate shape obtained by curving it. A thickness of the support member is not particularly limited, but is preferably from 0.05 mm to 0.15 mm. If the thickness of the support member is 0.05 mm or more, the blade member can be brought into abutment with the developer carrying member with a proper abutting pressure, and thus the toner on the developer carrying member can be controlled to a proper thickness. On the other hand, if the thickness of the support member is 0.15 mm or less, the blade member is made to easily follow the developer carrying member, and the developer control blade has a spring property that applies a pressure required for the toner.

A positional relationship between the blade member and the support member is not particularly limited, and the blade member may be disposed on one surface of the support member on a side on which it abuts the developer carrying member, or the blade member may be disposed to cover the entire surface of the support member. Also, a shape of an abutting side of the blade member with the developer carrying member is not particularly limited, and may be any of a flat surface, a curved surface, a convex shape, and a concave shape.

Formation of the blade member can be performed by extrusion molding, coating molding, sheet lamination molding, injection molding, or the like. Specifically, the following formation methods (1) to (3) can be exemplified.

(1) In the case of extrusion molding, a support member, optionally coated with adhesive, is placed in a mold, and the heated and melted thermoplastic elastomer composition is injected into the mold to form a molded product.

(2) In the case of sheet lamination molding, the thermoplastic elastomer formed into a sheet by extrusion molding or the like is bonded to a support member coated with an adhesive.

(3) In the case of injection molding, the thermoplastic elastomer composition is injected into a mold cavity containing a support member, and then cooled to form a molded product.

In forming the blade member, an adhesive layer can be formed on the support member, if needed. Examples of materials for the adhesive layer include, for example, hot-melt-based adhesives such as polyurethane-based, polyester based, ethylene vinyl alcohol (EVA)-based, and polyamide based adhesives.

### <<Electrophotographic Apparatus>

An electrophotographic image forming apparatus preferably includes a developing member. The developing member according to the present disclosure can be suitably used as a developer carrying member or a developer control member in an electrophotographic apparatus. The developing member can also be applied to any developing apparatus of non-contact developing apparatuses and contact developing apparatuses using magnetic single-component toner or non-magnetic single-component toner, and developing apparatuses using two-component toner.

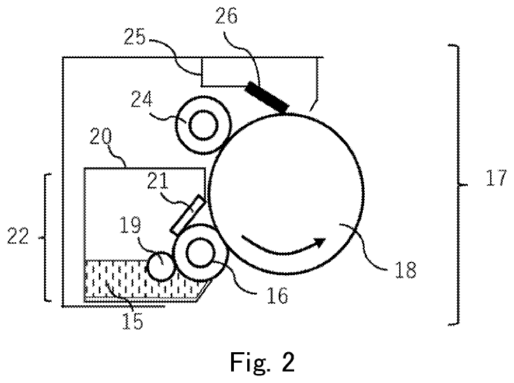

FIG. 2 is a schematic cross-sectional view showing an example of an electrophotographic apparatus in which the developing member according to the present disclosure is mounted as a developing roller in a contact-type developing apparatus using single-component toner. As shown in FIG. 2, a developing apparatus 22 is detachably mounted to the electrophotographic apparatus. The developing apparatus 22 is configured of a toner container 20 storing toner 15 as single-component toner, a developing roller 16, a toner supply roller 19 that supplies toner to the developing roller 16, and a developing blade 21 that controls a thickness of a toner layer on the developing roller 16. The developing roller 16 is located in an opening portion extending in a longitudinal direction in the toner container 20, and is placed to be opposed to a photoreceptor 18. In addition, a process cartridge 17 configured of the photoreceptor 18, a cleaning blade 26, a waste toner container 25, and a charging roller 24 is detachably mounted in the electrophotographic apparatus. Also, the photoreceptor 18, the cleaning blade 26, the waste toner container 25, and the charging roller 24 may be disposed in a main body of the electrophotographic apparatus.

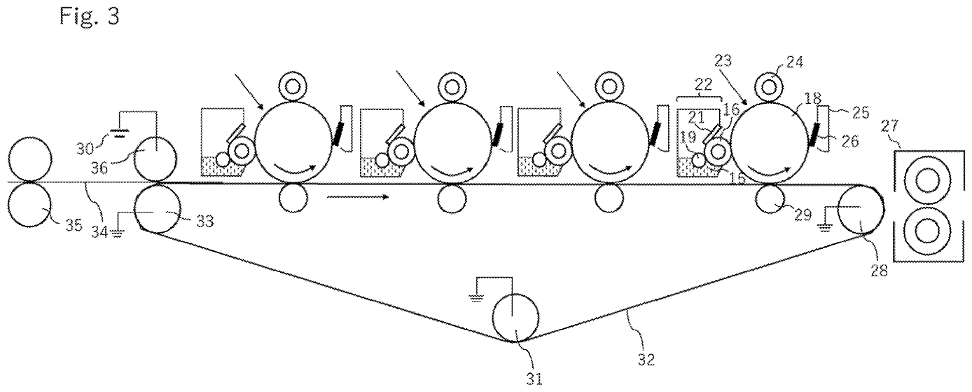

A printing operation of the electrophotographic apparatus will be described below. FIG. 3 is a schematic cross-sectional view of an example of the electrophotographic apparatus according to one aspect of the present disclosure. The photoreceptor 18 rotates in the arrow direction and is uniformly charged by the charging roller 24 for charging the photoreceptor 18. Next, an electrostatic latent image is formed on the surface of the photoreceptor 18 by a laser beam 23, which serves as an exposure means. This electrostatic latent image is visualized as a toner image by applying the toner 15 using the developing apparatus 22, which is disposed in contact with the photoreceptor 18 (development). The development is a so-called reversal development, in which the toner image is formed on an exposure unit. The toner image formed on the photoreceptor 18 is transferred to paper 34, which is a recording medium, with a transfer roller 29, which is a transfer member. The paper 34 is fed into the apparatus via a paper feed roller 35 and an attraction roller 36, and is conveyed between the photoreceptor 18 and the transfer roller 29 with an endless belt-like transfer conveyor belt 32. The transfer conveyor belt 32 is driven by a driven roller 33, a driver roller 28, and a tension roller 31. A voltage is applied from a bias power source 30 to the transfer roller 29 and the attraction roller 36. The paper 34 to which the toner image has been transferred is subjected to a fixing treatment by a fixing apparatus 27, and then discharged to the outside of the apparatus, thereby completing the printing operation. On the other hand, transfer residual toner remaining on the photoreceptor 18 without being transferred is scraped off with the cleaning blade 26, which is a cleaning member for cleaning the photoreceptor surface, and stored in the waste toner container 25. The cleaned photoreceptor 18 repeats the foregoing printing operation.

### <<Electrophotographic Process Cartridge>>

The developing roller according to the present disclosure can be suitably used as a developing member such as a developer carrying member, a developer supplying and scraping member, and a developer control member in a process cartridge. That is, the electrophotographic process cartridge of the present disclosure is an electrophotographic process cartridge configured to be detachably attached to the main body of the electrophotographic apparatus and includes the developing member of the present disclosure.

### EXAMPLES

The present disclosure will be further described in detail below using specific examples. The technical scope of the present disclosure is not limited to these examples. In the following formulation, “parts” refers to “parts by mass” unless otherwise specified.

### <Preparation of Base>

As the base, a base was prepared by applying a primer (product name: DY35-051, manufactured by Dow Corning Toray Co., Ltd.) to a SUS304 core metal having an outer diameter of 6 mm and a length of 264 mm and heating it at a temperature of 150° C. for 20 minutes. This conductive base was installed concentrically within a cylindrical mold having an inner diameter of 11.5 mm.

As materials for the elastic layer, the materials shown in Table 1 below were mixed using Trimix (product name: TX-15, manufactured by INOUE MFG., INC.) to form an addition-type silicone rubber composition, which was then poured into the mold heated to 115° C. After the materials were poured, they were heated and molded at a temperature of 120° C. for 10 minutes, cooled to room temperature, and then released from the mold to obtain an elastic roller with an intermediate layer having a thickness of 2.71 mm formed on an outer circumference of the conductive base.

TABLE 1

| | Parts |
|---|---|
| Material | by mass |
| Liquid dimethylpolysiloxane having two or more | 100.0 |
| alkylene groups bonded to silicon atoms per | |
| molecule (Product name: SF3000E, Viscosity: | |
| 10,000 cp, Vinyl group equivalent 0.05 mmol/g, | |
| manufactured by KCC Corp.) | |
| Platinum-based catalyst (Product name: | 0.048 |
| SIP6832.2, manufactured by Gelest Inc.) | |
| Liquid dimethylpolysiloxane having two or more | 0.5 |
| alkylene groups bonded to silicon atoms per | |
| molecule (Product name: SP6000P, Si—H | |
| group equivalent: 15.5 mmol/g, manufactured | |
| by KCC Corp.) | |
| Carbon black (Product name: Tokablack | 6.0 |
| #7360SB, manufactured by Tokai Carbon Co., Ltd.) | |

### Synthesis of Polyetherdiol with Branched Structure

### Synthesis of Polyetherdiol A-1

A mixture of 230.7 g (3.2 mol) of dry tetrahydrofuran (Tokyo Chemical Industry Co., Ltd.) and 68.9 g (0.8 mol) of dry 3-methyltetrahydrofuran (Tokyo Chemical Industry Co., Ltd.) (molar ratio: 80/20) was maintained at 10° C. in a reaction vessel. 13.1 g of 70% by mass perchloric acid and 120 g of acetic anhydride were added, and the reaction was performed for 2.5 hours.

Next, the reaction mixture was poured into 600 g of 20% by mass aqueous sodium hydroxide solution for purification. Further, remaining water and solvent components were removed under reduced pressure, and 218 g of liquid polyether diol A-1 was obtained. The number-average molecular weight of the polyether diol A-1 was 2000, and the hydroxyl value was 57 mgKOH/g.

### Synthesis of Acrylic Polyol

Acrylic polyol was synthesized as a raw material for the cross-linked acrylic structure.

### Synthesis of Acrylic Polyol B-1

245 parts of 2-hydroxyethyl methacrylate, 160 parts of ¿-caprolactone, 0.2 parts of hydroquinone monomethyl ether as a polymerization inhibitor, and 0.02 parts of stannous chloride as a reaction catalyst were placed in a reaction vessel equipped with a stirrer, a thermometer, a reflux tube, and an air inlet tube, and were reacted at 100° C. for 24 hours while blowing air, yielding lactone-modified 2-hydroxyethyl methacrylate.

Next, 300 parts by mass of dry methyl ethyl ketone was charged into a reaction vessel equipped with a stirrer, a thermometer, a reflux tube, a dropper, and a nitrogen gas inlet tube, and the temperature was raised to 87° C. under a nitrogen gas stream and heated to reflux. Next, a mixture of 50.0 parts by mass of the lactone-modified 2-hydroxyethyl methacrylate obtained by the above operation, 50.0 parts by mass of styrene, and 0.2 parts by mass of an initiator (product name: Kaya Ester O; manufactured by Kayaku Akzo Co., Ltd.) was gradually added dropwise over one hour. Then, the mixture was heated to reflux for an additional 3 hours while maintaining the temperature at 87° C. Next, the mixture was allowed to cool and the temperature was lowered to room temperature, yielding acrylic polyol B-1. The number-average molecular weight of acrylic polyol B-1 was 4,500, and the hydroxyl value was 80 mgKOH/g.

### Synthesis of Acrylic Polyol B-2

245 parts of 2-hydroxypropyl methacrylate, 160 parts of ε-caprolactone, 0.2 parts of hydroquinone monomethyl ether as a polymerization inhibitor, and 0.02 parts of stannous chloride as a reaction catalyst were placed in a reaction vessel equipped with a stirrer, a thermometer, a reflux tube, and an air inlet tube, and were reacted at 100° C. for 24 hours while blowing air, yielding lactone-modified 2-hydroxypropyl methacrylate.

Next, 300 parts by mass of dry methyl ethyl ketone was charged into a reaction vessel equipped with a stirrer, a thermometer, a reflux tube, a dropper, and a nitrogen gas inlet tube, and the temperature was raised to 87° C. under a nitrogen gas stream and heated to reflux. Next, a mixture of 50.0 parts by mass of lactone modified 2-hydroxypropyl methacrylate obtained by the above operation, 50.0 parts by mass of styrene, and 0.2 parts by mass of an initiator (product name: Kaya Ester O; manufactured by Kayaku Akzo Co., Ltd.) was gradually added dropwise over one hour. Then, the mixture was heated to reflux for an additional 3 hours while maintaining the temperature at 87° C. Next, the mixture was allowed to cool and the temperature was lowered to room temperature, yielding acrylic polyol B-2. The number-average molecular weight of acrylic polyol B-2 was 4,500, and the hydroxyl value was 76 mgKOH/g.

### Synthesis of Acrylic Polyol B-3

245 parts of 2-hydroxyethyl methacrylate, 160 parts of ε-caprolactone, 0.2 parts of hydroquinone monomethyl ether as a polymerization inhibitor, and 0.02 parts of stannous chloride as a reaction catalyst were placed in a reaction vessel equipped with a stirrer, a thermometer, a reflux tube, and an air inlet tube, and were reacted at 100° C. for 24 hours while blowing air, yielding lactone-modified 2-hydroxyethyl methacrylate.

300 parts by mass of dry methyl ethyl ketone was charged into a reaction vessel equipped with a stirrer, a thermometer, a reflux tube, a dropper, and a nitrogen gas inlet tube, and the temperature was raised to 87° C. under a nitrogen gas stream and heated to reflux. Next, a mixture of 100.0 parts by mass of the lactone-modified 2-hydroxyethyl methacrylate obtained by the above operation, and 0.2 parts by mass of an initiator (product name: Kaya Ester O; manufactured by Kayaku Akzo Co., Ltd.) was gradually added dropwise over one hour. Then, the mixture was heated to reflux for an additional 3 hours while maintaining the temperature at 87° C. Next, the mixture was allowed to cool and the temperature was lowered to room temperature, yielding acrylic polyol B-3. The number-average molecular weight of acrylic polyol B-3 was 3,500, and the hydroxyl value was 102 mgKOH/g.

### Synthesis of Acrylic Polyol B-4

245 parts of 2-hydroxypropyl methacrylate, 160 parts of ε-caprolactone, 0.2 parts of hydroquinone monomethyl ether as a polymerization inhibitor, and 0.02 parts of stannous chloride as a reaction catalyst were placed in a reaction vessel equipped with a stirrer, a thermometer, a reflux tube, and an air inlet tube, and were reacted at 100° C. for 24 hours while blowing air, yielding lactone-modified 2-hydroxypropyl methacrylate.

300 parts by mass of dry methyl ethyl ketone was charged into a reaction vessel equipped with a stirrer, a thermometer, a reflux tube, a dropper, and a nitrogen gas inlet tube, the temperature was raised to 87° C. under a nitrogen gas stream and heated to reflux. Next, a mixture of 100.0 parts by mass of the lactone-modified 2-hydroxypropyl methacrylate obtained by the above operation, and 0.2 parts by mass of an initiator (product name: Kaya Ester O; manufactured by Kayaku Akzo Co., Ltd.) was gradually added dropwise over one hour. Then, the mixture was heated to reflux for an additional 3 hours while maintaining the temperature at 87° C. Next, the mixture was allowed to cool and the temperature was lowered to room temperature, yielding acrylic polyol B-4. The number-average molecular weight of acrylic polyol B-4 was 3,500, and the hydroxyl value was 98 mgKOH/g.

### Acrylic Polyol B-5

300 parts by mass of dry methyl ethyl ketone was charged into a reaction vessel equipped with a stirrer, a thermometer, a reflux tube, a dropper, and a nitrogen gas inlet tube, and the temperature was raised to 87° C. under a nitrogen gas stream and heated to reflux. Next, a mixture of 100.0 parts by mass of 2-hydroxyethyl methacrylate, and 0.2 parts by mass of an initiator (product name: Kaya Ester O; manufactured by Kayaku Akzo Co., Ltd.) was gradually added dropwise over one hour. Then, the mixture was heated to reflux for an additional 3 hours while maintaining the temperature at 87° C. Next, the mixture was allowed to cool and the temperature was lowered to room temperature, yielding acrylic polyol B-5. The number-average molecular weight of acrylic polyol B-5 was 3,000, and the hydroxyl value was 126 mgKOH/g.

### Acrylic Polyol B-6

300 parts by mass of dry methyl ethyl ketone was charged into a reaction vessel equipped with a stirrer, a thermometer, a reflux tube, a dropper, and a nitrogen gas inlet tube, and the temperature was raised to 87° C. under a nitrogen gas stream and heated to reflux. Next, a mixture of 100.0 parts by mass of 2-hydroxypropyl methacrylate and 0.2 parts by mass of an initiator (product name: Kaya Ester O; manufactured by Kayaku Akzo Co., Ltd.) was gradually added dropwise over one hour. Then, the mixture was heated to reflux for an additional 3 hours while maintaining the temperature at 87° C. Next, the mixture was allowed to cool and the temperature was lowered to room temperature, yielding acrylic polyol B-6. The number-average molecular weight of acrylic polyol B-6 was 3,000, and the hydroxyl value was 124 mgKOH/g.

The acrylic polyols used in this study are shown in Table 2.

TABLE 2

| Acrylic | | | | Hydroxyl |
|---|---|---|---|---|
| Polyol | Mono- | Mono- | Mono- | value |
| No. | mer 1 | mer 2 | mer 3 | mgKOH/g |
| B-1 | 2-hydroxyethyl methacrylate | Capro- | Styrene | 80 |
| | | lactone | | |
| B-2 | 2-hydroxypropyl methacrylate | Capro- | Styrene | 76 |
| | | lactone | | |
| B-3 | 2-hydroxyethyl methacrylate | Capro- | — | 102 |
| | | lactone | | |
| B-4 | 2-hydroxypropyl methacrylate | Capro- | — | 98 |
| | | lactone | | |
| B-5 | 2-hydroxyethyl methacrylate | — | — | 126 |
| B-6 | 2-hydroxypropyl methacrylate | — | — | 124 |

### Synthesis of Isocyanate-Terminated Prepolymer

An isocyanate compound for forming a urethane resin was synthesized.

### Synthesis of Isocyanate-Terminated Prepolymer C-1

Under a nitrogen atmosphere, 100.0 parts by mass of polypropylene glycol-based polyol (product name: Exenol 230; manufactured by Asahi Glass Co., Ltd.) was gradually added dropwise to 33.8 parts by mass of polymeric MDI (product name: Millionate MR; manufactured by Tosoh Corporation) in a reaction vessel while maintaining the temperature inside the reaction vessel at 65° C.

After the dropping is completed, the reaction was carried out at 65° C. for 2 hours, and then 57.3 parts by mass of methyl ethyl ketone was added. The resulting reaction mixture was cooled to room temperature to yield isocyanate-terminated urethane prepolymer C-1 with an isocyanate group content of 4.80% by mass.

### <Production of Surface Layer Forming Coating Material and Fabrication of Developing Roller>

### Example 1

For 100 parts by mass of polytetramethylene glycol (product name: PTMG650, manufactured by Mitsubishi Chemical Corporation) as a polyol, 2.12 parts by mass of acrylic polyol B-1, 8.13 parts by mass of monool (product name: Newpol 50HB-660, manufactured by Sanyo Chemical Industries, Ltd.) and 139.9 parts by mass of isocyanate (product name: Millionate MR, manufactured by Tosoh Corporation) were prepared.

Further, for 100 parts by mass of these resin components (that is, a total of 100 parts by mass of polytetramethylene glycol, acrylic polyol B-1, monool, and isocyanate), 30 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Next, methyl ethyl ketone was added to achieve a total solids ratio of 30% by mass, and the mixture was mixed using a sand mill. Then, the viscosity was further adjusted to 10 to 13 cps with methyl ethyl ketone to adjust Dispersion 1.

To the above Dispersion 1, 10 parts by mass of polyurethane resin particles (product name: Dynamic Beads UCN-5150D, manufactured by Dainichiseika Color & Chemicals Mfg. Co., Ltd.) were added as resin particles for adjusting surface roughness for 100 parts by mass of the resin components, and was stirred for 10 minutes using a stirring motor to obtain a surface layer forming coating material 1.

Next, this surface layer forming coating material 1 was adjusted to a solid content of 27% by mass using MEK so that the surface layer has a film thickness of 13 μm, then dip-coated onto the elastic roller, and then dried. Thereafter, a surface layer was formed on the outer circumference of the elastic layer by heat treatment at 150° C. for 1 hour, yielding the developing roller of Example 1.

### Example 2

For 100 parts by mass of polytetramethylene glycol (product name: PTMG650, manufactured by Mitsubishi Chemical Corporation) as a polyol, 2.23 parts by mass of acrylic polyol B-2, 8.14 parts by mass of monool (product name: Newpol 50HB-660, manufactured by Sanyo Chemical Industries, Ltd.) and 140.1 parts by mass of isocyanate (product name: Millionate MR, manufactured by Tosoh Corporation) were prepared.

Further, for 100 parts by mass of these resin components, 30 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Example 2.

### Example 3

For 100 parts by mass of polytetramethylene glycol (product name: PTMG650, manufactured by Mitsubishi Chemical Corporation) as a polyol, 1.66 parts by mass of acrylic polyol B-3, 8.09 parts by mass of monool (product name: Newpol 50HB-660, manufactured by Sanyo Chemical Industries, Ltd.) and 139.3 parts by mass of isocyanate (product name: Millionate MR, manufactured by Tosoh Corporation) were prepared.

Further, for 100 parts by mass of these resin components, 30 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Example 3.

### Example 4

For 100 parts by mass of polytetramethylene glycol (product name: PTMG650, manufactured by Mitsubishi Chemical Corporation) as a polyol, 1.73 parts by mass of acrylic polyol B-4, 8.10 parts by mass of monool (product name: Newpol 50HB-660, manufactured by Sanyo Chemical Industries, Ltd.) and 139.4 parts by mass of isocyanate (product name: Millionate MR, manufactured by Tosoh Corporation) were prepared.

Further, for 100 parts by mass of these resin components, 30 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Example 4.

### Example 5

For 100 parts by mass of polytetramethylene glycol (product name: PTMG650, manufactured by Mitsubishi Chemical Corporation) as a polyol, 1.35 parts by mass of acrylic polyol B-5, 8.07 parts by mass of monool (product name: Newpol 50HB-660, manufactured by Sanyo Chemical Industries, Ltd.) and 138.8 parts by mass of isocyanate (product name: Millionate MR, manufactured by Tosoh Corporation) were prepared.

Further, for 100 parts by mass of these resin components, 30 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Example 5.

### Example 6

For 100 parts by mass of polytetramethylene glycol (product name: PTMG650, manufactured by Mitsubishi Chemical Corporation) as a polyol, 1.37 parts by mass of acrylic polyol B-6, 8.07 parts by mass of monool (product name: Newpol 50HB-660, manufactured by Sanyo Chemical Industries, Ltd.) and 138.9 parts by mass of isocyanate (product name: Millionate MR, manufactured by Tosoh Corporation) were prepared.

Further, for 100 parts by mass of these resin components, 30 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Example 6.

### Example 7

For 100 parts by mass of polytetramethylene glycol (product name: PTMG650, manufactured by Mitsubishi Chemical Corporation) as a polyol, 2.73 parts by mass of acrylic polyol B-1, 26.4 parts by mass of monool (product name: Newpol 50HB-660, manufactured by Sanyo Chemical Industries, Ltd.) and 150.3 parts by mass of isocyanate (product name: Millionate MR, manufactured by Tosoh Corporation) were prepared.

Further, for 100 parts by mass of these resin components, 30 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Example 7.

### Example 8

For 100 parts by mass of polytetramethylene glycol (product name: PTMG650, manufactured by Mitsubishi Chemical Corporation) as a polyol, 1.96 parts by mass of acrylic polyol B-1, 3.77 parts by mass of monool (product name: Newpol 50HB-660, manufactured by Sanyo Chemical Industries, Ltd.) and 137.5 parts by mass of isocyanate (product name: Millionate MR, manufactured by Tosoh Corporation) were prepared.

Further, for 100 parts by mass of these resin components, 30 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Example 8.

### Example 9

For 100 parts by mass of polytetramethylene glycol (product name: PTMG650, manufactured by Mitsubishi Chemical Corporation) as a polyol, 2.12 parts by mass of acrylic polyol B-1, 8.13 parts by mass of monool (product name: Newpol 50HB-660, manufactured by Sanyo Chemical Industries, Ltd.) and 137.6 parts by mass of isocyanate C-1 were prepared.

Furthermore, for 100 parts by mass of these resin components, 30 parts by mass of carbon black (product name: MA230, manufactured by Mitsubishi Chemical Corporation) and 3 parts by mass of a leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Example 9.

### Example 10

For 100 parts by mass of polyether diol A-1 as a polyol, 2.12 parts by mass of acrylic polyol B-1, 8.13 parts by mass of monool (product name: Newpol 50HB-660, manufactured by Sanyo Chemical Industries, Ltd.) and 128.5 parts by mass of isocyanate (product name: Millionate MR, manufactured by Tosoh Corporation) were prepared.

Further, for 100 parts by mass of these resin components, 30 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Example 10.

### Example 11

For 100 parts by mass of polyether diol A-1 as a polyol, 2.12 parts by mass of acrylic polyol B-1, 8.13 parts by mass of monool (product name: Newpol 50HB-660, manufactured by Sanyo Chemical Industries, Ltd.) and 118.2 parts by mass of isocyanate C-1 were prepared.

Further, for 100 parts by mass of these resin components, 30 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Example 11.

### Example 12

For 100 parts by mass of polytetramethylene glycol (product name: PTMG650, manufactured by Mitsubishi Chemical Corporation) as a polyol, 2.12 parts by mass of acrylic polyol B-1, 2.24 parts by mass of monool (product name: Newpol 50HB-100, manufactured by Sanyo Chemical Industries, Ltd.) and 130.2 parts by mass of isocyanate C-1 were prepared.

Further, for 100 parts by mass of these resin components, 30 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Example 12.

### Example 13

For 100 parts by mass of polytetramethylene glycol (product name: PTMG650, manufactured by Mitsubishi Chemical Corporation) as a polyol, 2.12 parts by mass of acrylic polyol B-1, 14.1 parts by mass of monool (product name: Newpol 50HB-2000, manufactured by Sanyo Chemical Industries, Ltd.) and 146.7 parts by mass of isocyanate C-1 were prepared.

Furthermore, for 100 parts by mass of these resin components, 30 parts by mass of carbon black (product name: MA230, manufactured by Mitsubishi Chemical Corporation) and 3 parts by mass per resin component of a leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Example 13.

### Example 14

For 100 parts by mass of polytetramethylene glycol (product name: PTMG650, manufactured by Mitsubishi Chemical Corporation) as a polyol, 2.12 parts by mass of acrylic polyol B-1, 8.13 parts by mass of monool (product name: Newpol 50HB-660, manufactured by Sanyo Chemical Industries, Ltd.), and 137.6 parts by mass of isocyanate C-1 were prepared.

Further, for 100 parts by mass of these resin components, 25 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Example 14.

### Example 15

For 100 parts by mass of polytetramethylene glycol (product name: PTMG650, manufactured by Mitsubishi Chemical Corporation) as a polyol, 2.12 parts by mass of acrylic polyol B-1, 8.13 parts by mass of monool (product name: Newpol 50HB-660, manufactured by Sanyo Chemical Industries, Ltd.) and 137.6 parts by mass of isocyanate C-1 were prepared.

Further, for 100 parts by mass of these resin components, 35 parts by mass of carbon black (product name: MA230, manufactured by Mitsubishi Chemical Corporation) and 3 parts by mass of a leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Example 15.

Table 3 shows a list of the surface layer materials according to Examples 1 to 15.

TABLE 3

| | | | Number of | Terminal | | | | | |
|---|---|---|---|---|---|---|---|---|---|
| | | | parts of | structure | Parts | | Parts | | CB |
| Example | Polyol A | Polyol B | polyol B | material | by mass | Isocyanate | by mass | CB | parts |
| Example 1 | PT MG650 | B-1 | 2.12 | HB660 | 8.13 | Millionate MR | 139.9 | MA230 | 30 |
| Example 2 | PT MG650 | B-2 | 2.23 | HB660 | 8.14 | Millionate MR | 140.1 | MA230 | 30 |
| Example 3 | PT MG650 | B-3 | 1.66 | HB660 | 8.09 | Millionate MR | 139.3 | MA230 | 30 |
| Example 4 | PT MG650 | B-4 | 1.73 | HB660 | 8.10 | Millionate MR | 139.4 | MA230 | 30 |
| Example 5 | PT MG650 | B-5 | 1.35 | HB660 | 8.07 | Millionate MR | 138.8 | MA230 | 30 |
| Example 6 | PT MG650 | B-6 | 1.37 | HB660 | 8.07 | Millionate MR | 138.9 | MA230 | 30 |
| Example 7 | PT MG650 | B-1 | 2.73 | HB660 | 26.4 | Millionate MR | 150.3 | MA230 | 30 |
| Example 8 | PT MG650 | B-1 | 1.96 | HB660 | 3.77 | Millionate MR | 137.5 | MA230 | 30 |
| Example 9 | PT MG650 | B-1 | 2.12 | HB660 | 8.13 | C-1 | 137.6 | MA230 | 30 |
| Example 10 | A-1 | B-1 | 2.12 | HB660 | 8.13 | Millionate MR | 128.5 | MA230 | 30 |
| Example 11 | A-1 | B-1 | 2.12 | HB660 | 8.13 | C-1 | 118.2 | MA230 | 30 |
| Example 12 | PT MG650 | B-1 | 2.12 | HB100 | 2.24 | C-1 | 130.2 | MA230 | 30 |
| Example 13 | PT MG650 | B-1 | 2.12 | HB2000 | 14.1 | C-1 | 146.7 | MA230 | 30 |
| Example 14 | PT MG650 | B-1 | 2.12 | HB660 | 8.13 | C-1 | 137.6 | MA230 | 25 |
| Example 15 | PT MG650 | B-1 | 2.12 | HB660 | 8.13 | C-1 | 137.6 | MA230 | 35 |

In the table, the number of parts of polyol B is the number of parts per 100 parts of polyol A. CB represents carbon black, and CB parts represents the number of parts of carbon black per 100 parts of the resin components.

### Comparative Example 1

For 100 parts by mass of polytetramethylene glycol (product name: PTMG650, manufactured by Mitsubishi Chemical Corporation) as a polyol, 8.13 parts by mass of monool (product name: Newpol 50HB-660, manufactured by Sanyo Chemical Industries, Ltd.) and 139.9 parts by mass of isocyanate (product name: Millionate MR, manufactured by Tosoh Corporation) were prepared.

Further, for 100 parts by mass of these resin components, 30 parts by mass of carbon black (product name: MA230, manufactured by Mitsubishi Chemical Corporation) and 3 parts by mass of a leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Comparative Example 1.

### Comparative Example 2

For 100 parts by mass of acrylic polyol B-1 as a polyol, 8.13 parts by mass of monool (product name: Newpol 50HB-660, manufactured by Sanyo Chemical Industries, Ltd.) and 139.9 parts by mass of isocyanate (product name: Millionate MR, manufactured by Tosoh Corporation) were prepared.

Further, for 100 parts by mass of these resin components, 30 parts by mass of carbon black (product name: MA230, manufactured by Mitsubishi Chemical Corporation) and 3 parts by mass of a leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Comparative Example 2.

### Comparative Example 3

For 100 parts by mass of polytetramethylene glycol (product name: PTMG650, manufactured by Mitsubishi Chemical Corporation) as a polyol, 2.12 parts by mass of acrylic polyol B-1, 8.13 parts by mass of monool (product name: Newpol 50HB-660, manufactured by Sanyo Chemical Industries, Ltd.) and 139.9 parts by mass of isocyanate (product name: Millionate MR, manufactured by Tosoh Corporation) were prepared.

Further, for 100 parts by mass of these resin components, 23 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Comparative Example 3.

### Comparative Example 4

For 100 parts by mass of polytetramethylene glycol (product name: PTMG650, manufactured by Mitsubishi Chemical Corporation) as a polyol, 2.12 parts by mass of acrylic polyol B-1, 8.13 parts by mass of monool (product name: Newpol 50HB-660, manufactured by Sanyo Chemical Industries, Ltd.) and 139.9 parts by mass of isocyanate (product name: Millionate MR, manufactured by Tosoh Corporation) were prepared.

Further, for 100 parts by mass of these resin components, 37 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Comparative Example 4.

### Comparative Example 5

For 100 parts by mass of polytetramethylene glycol (product name: PTMG650, manufactured by Mitsubishi Chemical Corporation) as a polyol, 3.90 parts by mass of acrylic polyol B-1, 60.3 parts by mass of monool (product name: Newpol 50HB-660, manufactured by Sanyo Chemical Industries, Ltd.) and 169.6 parts by mass of isocyanate (product name: Millionate MR, manufactured by Tosoh Corporation) were prepared.

Further, for 100 parts by mass of these resin components, 30 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Thereafter, the same operations as those in Example 1 were carried out to obtain a developing roller of Comparative Example 5.

### Comparative Example 6

For 100 parts by mass of polytetramethylene glycol (product name: PTMG650, manufactured by Mitsubishi Chemical Corporation) as a polyol, 1.88 parts by mass of acrylic polyol B-1, 1.83 parts by mass of monool (product name: Newpol 50HB-660, manufactured by Sanyo Chemical Industries, Ltd.) and 136.3 parts by mass of isocyanate (product name: Millionate MR, manufactured by Tosoh Corporation) were prepared.

Further, for 100 parts by mass of these resin components, 30 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Thereafter, the same operations as in Example 1 were carried out to obtain a developing roller of Comparative Example 6.

### Comparative Example 7

For 100 parts by mass of polyether diol A-1 as a polyol, 1.95 parts by mass of acrylic polyol B-1, 1.88 parts by mass of monool (product name: Newpol 50HB-660, manufactured by Sanyo Chemical Industries, Ltd.) and 138.4 parts by mass of isocyanate C-1 were prepared.

Further, for 100 parts by mass of these resin components, 30 parts by mass of carbon black (product name: MA230, manufactured by Mitsubishi Chemical Corporation) and 3 parts by mass of a leveling agent (product name: TSF4445, manufactured by Momentive Performance Materials, Inc.) were prepared, and the above materials also including the resin components were mixed.

Thereafter, the same operation as that of Example 1 was carried out to obtain a developing roller of Comparative Example 7.

### Comparative Example 8

For 100 parts by mass of polytetramethylene glycol (product name: PTMG650, manufactured by Mitsubishi Chemical Corporation) as a polyol, 3.21 parts by mass of Monool (product name: Newpol 50HB-660, manufactured by Sanyo Chemical Industries, Ltd.) and 139.7 parts by mass of Isocyanate C-1 were prepared.

Further, for 100 parts by mass of these resin components, 30 parts by mass of carbon black (product name: MA230, manufactured by Mitsubishi Chemical Corporation) and 3 parts by mass of leveling agent (product name: TSF4445, manufactured by Momentive Performance Materials, Inc.) were prepared, and the above materials also including the resin components were mixed.

Next, methyl ethyl ketone was added to achieve a total solids ratio of 30% by mass, and the mixture was then mixed using a sand mill. Then, the viscosity was further adjusted to 10 to 13 cps with methyl ethyl ketone to adjust the dispersion.

To the dispersion, 10 parts by mass of polyurethane resin particles (product name: Dynamic Beads UCN-5150D, manufactured by Dainichiseika Color & Chemicals Mfg. Co., Ltd.) were added as resin particles for adjusting surface roughness for 100 parts by mass of the resin components, and stirred for 10 minutes using a stirring motor to obtain a surface layer forming coating material.

Next, this surface layer forming coating material 1 was adjusted to a solid content of 27% by mass using MEK so that the surface layer has a film thickness of 13 μm, then dip-coated onto the elastic roller, and then dried. Thereafter, a surface layer was formed on the outer circumference of the elastic layer by heat treatment at 150° C. for 1 hour, yielding a surface layer formed roller.

Subsequently, acrylic monomer impregnating and curing treatment were carried out using the following method. As a material of a impregnating treatment solution for the impregnating treatment, 0.25 parts by mass of a photopolymerization initiator (product name: IRGACURE184, manufactured by BASF Corporation) was dissolved and mixed with 5 parts by mass of bifunctional acrylic monomer (product name: EBECRYL145, manufactured by Daicel Ornex Co., Ltd.) in 100 parts by mass of MEK.

The surface layer formed roller was dipped in the impregnating treatment solution for 2 seconds to impregnate it with an acrylic monomer component. Thereafter, it was air-dried at room temperature for 30 minutes, and then dried at 90° C. for 1 hour to volatilize the solvent. After drying, the elastic roller was rotated and irradiated with ultraviolet rays at an integrated light intensity of 15,000 mJ/cm² to cure the acrylic monomer and form a surface layer. Also, a high-pressure mercury lamp (product name: Handheld UV curing system, manufactured by Mario Network) was used as a ultraviolet rays irradiation device.

A developing roller of Comparative Example 8 was obtained by the above operations.

Table 4 shows a list of the surface layer materials according to Comparative Examples 1 to 8.

TABLE 4

| | | | | Presence or absence | | | | | | |
|---|---|---|---|---|---|---|---|---|---|---|
| | | | | of interpenetrating | | | | | | |
| | | | Number of | polymeric mesh | Terminal | | | | | |
| Comparative | | | parts of | structure due to cross- | structure | Parts | | Parts | | CB |
| Example | Polyol A | Polyol B | polyol B | linked acrylic resin | material | by mass | Isocyanate | by mass | CB | parts |
| Comparative | PT MG650 | — | — | None | HB660 | 8.13 | Millionate MR | 139.9 | MA230 | 30 |
| Example 1 | | | | | | | | | | |
| Comparative | — | B-1 | — | None | HB660 | 8.13 | Millionate MR | 139.9 | MA230 | 30 |
| Example 2 | | | | | | | | | | |
| Comparative | PT MG650 | B-1 | 2.12 | None | HB660 | 8.13 | Millionate MR | 139.9 | MA230 | 23 |
| Example 3 | | | | | | | | | | |
| Comparative | PT MG650 | B-1 | 2.12 | None | HB660 | 8.13 | Millionate MR | 139.9 | MA230 | 37 |
| Example 4 | | | | | | | | | | |
| Comparative | PT MG650 | B-1 | 3.90 | None | HB660 | 60.3 | Millionate MR | 169.6 | MA230 | 30 |
| Example 5 | | | | | | | | | | |
| Comparative | PT MG650 | B-1 | 1.88 | None | HB660 | 1.83 | Millionate MR | 136.3 | MA230 | 30 |
| Example 6 | | | | | | | | | | |
| Comparative | A-1 | B-1 | 1.95 | None | HB660 | 1.88 | C-1 | 138.4 | MA230 | 30 |
| Example 7 | | | | | | | | | | |
| Comparative | PT MG650 | — | — | Present | HB660 | 3.21 | C-1 | 139.7 | MA230 | 30 |
| Example 8 | | | | | | | | | | |

In the table, the number of parts of polyol B is the number of parts per 100 parts of polyol A. CB represents carbon black, and CB parts represents the number of parts of carbon black per 100 parts of the resin components.

### <Confirmation of Composition of Product>

### (X-ray Photoelectron Spectroscopy Measurement)

With respect to surface compositions of the developing rollers according to Examples 1 to 15 and Comparative Examples 1 to 8, a proportion of nitrogen atoms N1 (atomic %), a proportion of oxygen atoms forming ether structure O1 (atomic %), a proportion of carbon atoms adjacent to oxygen that are not carbon atoms forming carbonyl structure C1 (atomic %), and a proportion of carbon atoms forming carbonyl structure in acrylic structure C2 (atomic %) were confirmed by X-ray photoelectron spectroscopy (hereinafter sometimes referred to as “ESCA”).

ESCA Analyzer: Product Name: Quantum2000, manufactured by ULVAC-PHI, Inc.
Detected Elements: C, N, O;
X-ray Source: Monochrome Al Kα;
X-ray Setting: 100 μmφ (25 W (15 KV));
Photoelectron Take-off Angle: 45 degrees;
Neutralization Conditions: Neutralization gun and ion gun used together;
Analysis Area: φ100 μm;
Pass Energy: 23.5 eV;
Step Size: 0.1 eV.

N1, O1, C1, and C2 are determined from the atomic % of C, N, and O elements detected by quantitative analysis in ESCA measurement, and the area ratio of the C1s peak detected by state analysis. Also, in the C1s peak, the area intensity obtained from the detection peak in 286.5 eV was defined as C1, and the area intensity obtained from the detection peak in 289.1 eV was defined as C*. For C*, in order to remove carbonyl groups in urethane bonds, the value obtained by subtracting the intensity obtained by multiplying the area intensity of the N1s peak by a cross-section ratio of 1.8 from the area intensity of C* was defined as C2. In the O1 peak, the value obtained by dividing the area intensity of C* by a cross-section ratio of 2.93 was doubled, and then subtracted from the area intensity of the O1s peak was defined as a numerical value of O1.

In addition, the ESCA measurement was performed at three different points on the surface of the developing roller, and the arithmetic mean value thereof was used.

For each sample, a razor was used to make an incision from the surface of the developing roller toward the base, and a rubber piece was cut out with the cross-section of the surface layer and the elastic layer exposed. To prevent the influence of dirt on the rubber piece, the rubber piece was applied to MEK 200 ml, and washed with agitation in a sealed container for 24 hours.

### (Measurement of Parts by Mass of Carbon Black and Resin Particles for Adjusting Surface Roughness)

32 g of the surface layer peeled from the developing roller according to Example 1, 320 ml of diethanolamine (manufactured by Tokyo Chemical Industry Co., Ltd.) serving as a decomposing agent, and 1.5 ml of pure water were added to a flask equipped with a Dimroth tube, and heated to reflux at 160° C. for 20 hours while stirring. After the reaction, 300 ml of MEK was added to the solution, and the mixture was centrifuged. Further, the mixture was washed twice with 200 ml of MEK and centrifuged, and then dried under reduced pressure to separate the carbon black from the surface layer.

In addition, an amount of the resin particles for adjusting surface roughness contained in the surface layer was measured by the following procedure.

A 1 g sample of the surface layer peeled from the developing roller according to Example 1 was cut out and washed with 50 g of MEK for 2 hours by stirring. The obtained sample was dried at 60° C. for 12 hours and then subjected to thermogravimetric analysis using TG-MS systems (manufactured by Rigaku Corporation and Agilent Technologies, Inc.). The gas generated by decomposition was subjected to MS measurement to identify resin particles and binder components. A mass of the resin particles was obtained from the results of thermogravimetry and MS measurement.

The mass obtained by subtracting the mass of carbon black and resin particles for adjusting surface roughness from the mass of the surface layer was defined as that of the resin containing the acrylic structure and the urethane structure. The number of parts by mass of the carbon black with respect to 100 parts by mass of the resin containing the acrylic structure and the urethane structure was calculated.

(Measurement of Containing Proportion of Resin Containing Acrylic Structure and Urethane Structure in Resin Formed in Region from Outermost Surface to Depth of 0.1 μm of Developing Member)

From the developing roller according to Example 1, 800 pieces of a 2 mm×50 mm slice with a thickness of 0.1 μm were cut out from the outermost surface using a microtome. Thermogravimetry was performed on the collected thin slices, and it was confirmed that a change in weight change due to the resin containing the acrylic structure and the urethane structure in the TG curve was 80% by mass or greater.

### (Analysis of Structure of Resin Containing Acrylic Structure and Urethane Structure on Surface of Developing Member)

A 1 g sample of the surface layer from the developing roller according to Example 1 was cut out and subjected to GC-MS measurement in the same manner as described above. Also, a 1 cm square sample of the surface layer from the developing roller of Example 1 was cut out again and subjected to ATR-IR measurement using an FT/IR-4700 (manufactured by JASCO Corporation). From the above measurements, the presence of fragments of PTMG, MDI, hydroxyethyl methacrylate, caprolactone, and styrene, and Infrared absorption originating from urethane bonds were confirmed.

### <Scratch Resistance Evaluation>

### (Roller Dynamic Friction Measurement)

A 0.1 mm thick, 30 mm wide PET film (Lumirror S10, manufactured by Toray Industries, Inc.) was placed around the circumferential surface of the developing roller, and one end portion of the PET film was caused to extend horizontally to be attached to a digital force gauge. A 50 g weight was attached to the other end portion of the PET film and pulled vertically, so that the film was placed in contact with the surface of the developing roller over an angle of θ=90°. In addition, the digital force gauge was adjusted to read 0 when no load was applied, with neither the PET film nor the weight attached.

Next, once a value of the digital force gauge was stabilized with the PET film and the weight attached, the developing roller was rotated circumferentially at 230 rpm to rub against the PET film, and the digital force gauge measured a rubbing force between the developing roller and the PET film. As for measured values, analog output values from the digital force gauge were sampled at a rate of 100 points/s for 10 seconds, an average value was calculated from data of 500 points sampled from 5 seconds to 10 seconds, and the dynamic friction coefficient was calculated from those values.

### (Fracture Evaluation)

A laser printer (product name: LBP7700C, manufactured by Canon Inc.) configured as shown in FIG. 3 was placed in an H/H environment, and the developing roller of the present example was loaded into a process cartridge and left inside the laser printer for 24 hours. Thereafter, in the same environment, images in which the alphabet letter “E” with a 4-point size was printed at a print rate of 2% of an area of A4 paper were continuously output on A4 evaluation paper (GF-C081, manufactured by Canon Inc.). An end portion of the roller was observed every 2,000 sheets to check for a fracture on the roller surface layer. If no fractures were observed after printing 10,000 sheets, an equivalent amount of toner to that of a new cartridge is replenished, and the evaluation is continued. The evaluation was continued up to 30,000 sheets, and the number of printed sheets when the fracture was confirmed were defined as the number of fracture occurrence sheets.

### <Charging Performance Evaluation>

### (Toner Charge Quantity on Roller (Q/M))

The developing roller of the present example was loaded into a process cartridge, installed in a main body of the laser printer described above, and left in an L/L environment for 24 hours. Thereafter, in the same environment, images in which the alphabet letter “E” with a 4-point size was printed at a print rate of 2% of an area of A4 paper were continuously output on A4 evaluation paper (GF-C081, manufactured by Canon Inc.).

After outputting 1000 sheets, the printer was left for 15 hours, then output a solid white image, and the toner carried on the developing roller was collected by suction using a metal cylindrical tube and a cylindrical filter while measuring the charge quantity with an electrometer (product name: 6514, manufactured by Keithley). A toner charge quantity per unit mass, Q/M (nC/mg), was calculated from a mass M of the collected toner and a charge quantity Q of the collected toner, and was defined as the toner charge quantity (Q/M).

### (Fogging Evaluation)

The developing roller of the present example was loaded into a process cartridge, installed in the main body of the above-mentioned laser printer, and left in an L/L environment for 24 hours. Thereafter, in the same environment, images in which the alphabet letter “E” with a 4-point size was printed at a print rate of 2% of an area of A4 paper were continuously output on A4 evaluation paper (GF-C081, manufactured by Canon Inc.). A solid white image was output for every 1000 sheets printed, and this was repeated up to 10000 sheets, and fog values were measured in the following method.

A reflection densitometer (product name: TC-6DS/A, manufactured by Tokyo Denshoku Technical Center Co., Ltd.) was used to measure a reflection density R1 of a recording material before image formation and a reflection density R2 of the recording material on which a solid white image was output, and an increase in reflection density (R2-R1) was defined as a “fog value” of an electrophotographic roller. The reflection density was measured across the entire image printing region of the recording material, and an arithmetic mean value was used for the recording material before image formation, and the maximum value was used for the recording material on which a solid white image was output.

Next, an arithmetic average of the fog values for each image up to 10000 sheets was calculated. Also, the smaller the fog value, the better, and usually, the toner is not transferred onto the transfer paper on which a solid white image was formed. If the charge quantity of the toner is insufficient, the toner moves onto the photoreceptor even during the formation of a solid white image, and is further transferred onto the transfer paper, increasing the fog value.

Table 5 shows the results of the above analysis and evaluation.

TABLE 5

| | | | | | | | Dynamic | |
|---|---|---|---|---|---|---|---|---|
| | N1 | | | | Q/M | | friction | Number of fracture |
| Example | atomic % | O1/N1 | C1/C2 | A | (nC/mg) | Fogging | coefficient | occurrence sheets |
| Example 1 | 1.27 | 29.6 | 5.77 | 86 | 33.9 | 1.2 | 1.1 | >30000 |
| Example 2 | 1.24 | 29.8 | 5.66 | 85 | 34.1 | 1.3 | 1.2 | >30000 |
| Example 3 | 1.18 | 28.7 | 5.48 | 85 | 31.4 | 1.6 | 1.3 | >30000 |
| Example 4 | 1.18 | 29.1 | 5.59 | 87 | 31.0 | 1.5 | 1.3 | >30000 |
| Example 5 | 1.16 | 29.5 | 5.19 | 84 | 31.4 | 1.7 | 1.4 | >30000 |
| Example 6 | 1.13 | 29.7 | 5.21 | 86 | 31.1 | 1.7 | 1.4 | >30000 |
| Example 7 | 1.21 | 39.8 | 6.90 | 87 | 33.4 | 1.4 | 1.6 | >30000 |
| Example 8 | 1.08 | 20.0 | 4.61 | 81 | 28.8 | 2.1 | 1.3 | >30000 |
| Example 9 | 1.19 | 31.5 | 5.98 | 83 | 31.8 | 1.3 | 1.3 | >30000 |
| Example 10 | 1.24 | 36.5 | 6.12 | 84 | 30.7 | 1.5 | 1.6 | >30000 |
| Example 11 | 1.25 | 37.8 | 6.09 | 83 | 31.8 | 1.5 | 1.6 | >30000 |
| Example 12 | 1.11 | 22.4 | 4.10 | 83 | 28.1 | 2.2 | 1.3 | >30000 |
| Example 13 | 1.31 | 38.1 | 6.78 | 84 | 30.8 | 1.4 | 1.5 | >30000 |
| Example 14 | 1.26 | 30.8 | 5.76 | 91 | 31.5 | 1.2 | 1.8 | >30000 |
| Example 15 | 1.28 | 30.4 | 5.64 | 82 | 27.4 | 2.6 | 1.2 | >30000 |
| Comparative | 1.24 | 28.7 | — | 83 | 29.9 | 1.8 | 2.5 | 18000 |
| Example 1 | | | | | | | | |
| Comparative | 0.98 | 36.8 | 1.18 | 84 | 24.8 | 5.4 | 1.2 | >30000 |
| Example 2 | | | | | | | | |
| Comparative | 1.08 | 41.2 | 5.67 | 94 | 30.2 | 1.8 | 2.4 | 24000 |
| Example 3 | | | | | | | | |
| Comparative | 0.99 | 29.2 | 5.71 | 76 | 25.1 | 4.8 | 0.9 | >30000 |
| Example 4 | | | | | | | | |
| Comparative | 1.26 | 41.6 | 10.0 | 91 | 28.9 | 2.1 | 2.7 | 12000 |
| Example 5 | | | | | | | | |
| Comparative | 0.94 | 18.6 | 2.12 | 82 | 25.7 | 4.6 | 1.2 | >30000 |
| Example 6 | | | | | | | | |
| Comparative | 0.91 | 17.9 | 3.78 | 83 | 26.9 | 3.2 | 1.8 | >30000 |
| Example 7 | | | | | | | | |
| Comparative | 1.09 | 18.4 | 3.43 | 72 | 26.7 | 3.7 | 1.1 | >30000 |
| Example 8 | | | | | | | | |

In the table, “A” indicates a containing proportion (% by mass) of the resins containing the acrylic structure and the urethane structure in the resins formed in a region from the outermost surface to a depth of 0.1 μm of the developing member.

### Discussion of Evaluation Results

Since the developing rollers of Examples 1 to 15 have the surfaces made of the resins containing the acrylic structure and the urethane structure that satisfy Formulas (A) to (C), they have a high toner charge quantity Q/M, a low friction coefficient, and exhibit good fogging performance and high scratch resistance.

In contrast, since the developing rollers of Comparative Examples 1 and 2 have a structure primarily configured of only a cross-linked urethane resin or cross-linked acrylic resin, it is believed that they are unable to achieve both toner charging performance and a low dynamic friction coefficient.

In addition, the developing roller of Comparative Example 3 was an example in which O1/N1 exceeds 39.8. It is believed that O1/N1 was high, and there was an excess of segments that improve surface flexibility, such as the terminal ether group-containing structure, which weakened the surface orientation of the hard segments. For that reason, the fracture occurred due to an increased dynamic friction coefficient on the developing member surface.

Also, it is believed that, since the blending amount of carbon black was small, the interaction between the carbon black and isocyanate was also weak, and the surface orientation of the hard segments was weakened, causing O1/N1 to exceed 39.8.

Comparative Example 4 is an example in which N1 was less than 1.08. Since the amount of nitrogen was small, the charge imparting property to the toner was low, resulting in fogging.

In addition, Comparative Example 5 is an example in which O1/N1 exceeds 39.8 and C1/C2 exceeds 6.90. Since the developing roller of Comparative Example 5 contains an excess of segments that improve surface flexibility, such as the terminal ether group-containing structure, it has a sparse cross-linking structure in the surface layer and a lack of acrylic components. For that reason, fracture of the member surface occurs.

In Comparative Example 6, N1 is less than 1.08, O1/N1 is less than 20.0, and C1/C2 is less than 4.10. The developing roller of Comparative Example 6 has a small amount of nitrogen and few segments that improve surface flexibility, such as the terminal ether group-containing structure. For that reason, it is believed that the toner rolling ability was poor, resulting in a low toner charge quantity and a high fog value.

Also, in Comparative Example 7, N1 is less than 1.08, O1/N1 is less than 20.0, and C1/C2 is less than 4.10. The developing roller of Comparative Example 7 uses a polyol with a branched structure in the main chain, but it is believed that, since there were few segments that improve surface flexibility, such as the terminal ether group-containing structure oriented on the uppermost surface of the roller, the urethane structure distributed in the vicinity of the outermost surface of the roller was small, resulting in a high fog value.

In Comparative Example 8, O1/N1 was less than 20.0 and C1/C2 was less than 4.10, indicating a lack of segments that improve surface flexibility, such as the terminal ether group-containing structure. The developing roller of Comparative Example 8 has a cross-linked acrylic structure as an interpenetrating polymer network structure while it has a low dynamic friction coefficient, but the toner rolling ability is low, and the toner charge quantity is low, resulting in occurrence of fogging.

According to the present disclosure, it is possible to provide a developing member that appropriately charges toner in a low-temperature, low-humidity environment and has excellent scratch resistance even when used over a long period of time in a high-temperature, high-humidity environment. In addition, according to the present disclosure, it is possible to provide an electrophotographic process cartridge and an electrophotographic image forming apparatus that contribute to the stable formation of high-quality electrophotographic images.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-068772, filed Apr. 18, 2025, which is hereby incorporated by reference herein in its entirety.

What is claimed is:

1. A developing member comprising:
a surface comprised a resin comprising an acrylic structure and a urethane structure, wherein
when a sum of carbon atoms, oxygen atoms, and nitrogen atoms detected by X-ray photoelectron spectroscopy on the surface is used as a reference,
a proportion of the nitrogen atoms is defined as N1 (atomic %),
a proportion of the oxygen atoms forming an ether structure is defined as O1 (atomic %),
a proportion of carbon atoms that are not carbon atoms forming a carbonyl structure among the carbon atoms adjacent to oxygen is defined as C1 (atomic %), and
a proportion of carbon atoms forming the carbonyl structure in the acrylic structure is defined as C2 (atomic %),
the N1, O1, C1, and C2 satisfy formulas (A) to (C) below:
1.08≤N1 (A);
20.0≤O1/N1≤39.8 (B); and
4.10≤C1/C2≤6.90 (C).

2. The developing member according to claim 1, wherein the resin comprises a structure represented by a structural formula (1) below: 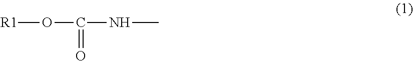
in the structural formula (1), R1 represents an organic group comprising an oxyalkylene structure that provides a number-average molecular weight (Mn) of 500 to 3500 for a portion of the structure represented by the structural formula (1).

3. The developing member according to claim 1, wherein the resin comprises an aromatic urethane structure.

4. The developing member according to claim 1, wherein the resin comprises a structure represented by a structural formula (2) below: 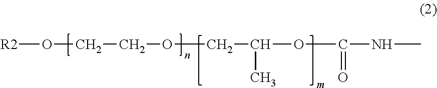
in the structural formula (2), R2 represents a linear or branched alkyl group with carbon number of 1 to 6, m and n each independently represent an integer of at least 1 that provides a number-average molecular weight of 500 to 3,500 for the structure represented by the structural formula (2), and arrangement of an ethylene oxide structure in parentheses to which n is attached and a propylene oxide structure in parentheses to which m is attached may be block polymerized or random polymerized.

5. The developing member according to claim 1, wherein the resin comprises a structure represented by a structural formula (3) below: 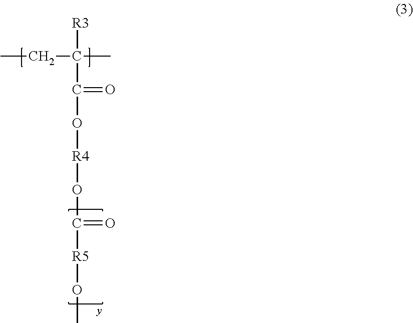
in the structural formula (3), y represents an integer of at least 1, R3 represents a hydrogen atom or a methyl group, R4 represents a methylene group with carbon number of 2 to 4, and R5 represents a methylene group with carbon number of 2 to 8.

6. The developing member according to claim 1, wherein the resin comprises a structure represented by a structural formula (4) below:

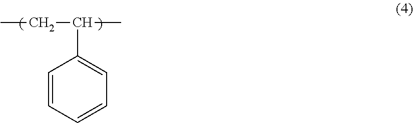

7. The developing member according to claim 1, wherein a resin accounting for at least 80% by mass of resins formed in a region from an outermost surface to a depth of 0.1 μm of the developing member is the resin.

8. The developing member according to claim 1, wherein the developing member comprises carbon black dispersed in the resin.

9. The developing member according to claim 8, wherein a content of the carbon black is 25 to 35 parts by mass per 100 parts by mass of the resin.

10. A process cartridge configured to be detachably attached to a main body of an electrophotographic image forming apparatus, the process cartridge comprising:
a developing member comprising:
a surface comprised a resin comprising an acrylic structure and a urethane structure, wherein
when a sum of carbon atoms, oxygen atoms, and nitrogen atoms detected by X-ray photoelectron spectroscopy on the surface is used as a reference,
a proportion of the nitrogen atoms is defined as N1 (atomic %),
a proportion of the oxygen atoms forming an ether structure is defined as O1 (atomic %),
a proportion of carbon atoms that are not carbon atoms forming a carbonyl structure among the carbon atoms adjacent to oxygen is defined as C1 (atomic %), and
a proportion of carbon atoms forming the carbonyl structure in the acrylic structure is defined as C2 (atomic %),
the N1, O1, C1, and C2 satisfy formulas (A) to (C) below:
1.08≤N1 (A);
20.0≤O1/N1≤39.8 (B); and
4.10≤C1/C2≤6.90 (C).

11. An electrophotographic image forming apparatus comprising:
a developing member comprising:
a surface comprised a resin comprising an acrylic structure and a urethane structure, wherein
when a sum of carbon atoms, oxygen atoms, and nitrogen atoms detected by X-ray photoelectron spectroscopy on the surface is used as a reference,
a proportion of the nitrogen atoms is defined as N1 (atomic %),
a proportion of the oxygen atoms forming an ether structure is defined as O1 (atomic %),
a proportion of carbon atoms that are not carbon atoms forming a carbonyl structure among the carbon atoms adjacent to oxygen is defined as C1 (atomic %), and
a proportion of carbon atoms forming the carbonyl structure in the acrylic structure is defined as C2 (atomic %),
the N1, O1, C1, and C2 satisfy formulas (A) to (C) below:
1.08≤N1 (A);
20.0≤O1/N1≤39.8 (B); and
4.10≤C1/C2≤6.90 (C).
